(19) United States
(12) Patent Application Publication
(10) Pub. No.: US 2025/0279047 A1
(43) Pub. Date: Sep. 4, 2025

(54) PIXEL CIRCUIT, DISPLAY PANEL, DISPLAY APPARATUS AND DRIVING METHOD

(71) Applicants: Chengdu BOE Optoelectronics Technology Co., Ltd., Chengdu, Sichuan (CN); BOE Technology Group Co., Ltd., Beijing (CN)

(72) Inventors: Xiaoxiao WANG, Beijing (CN); Changlong YUAN, Beijing (CN)

(21) Appl. No.: 18/857,252

(22) PCT Filed: Feb. 20, 2023
(86) PCT No.: PCT/CN2023/077182

§ 371 Date: Oct. 16, 2024

(51) Int. Cl. G09G 3/3233

(52) U.S. Cl. CPC G09G 3/3233; G09G 2300/0408; G09G 2300/0819; G09G 2300/0852; G09G 2300/0861; G09G 2310/061; G09G 2320/0233; G09G 2320/043; G09G 2330/023

(57) ABSTRACT

A pixel circuit, a display panel, a display apparatus and a driving method are provided. The pixel circuit includes: a light-emitting device; a driving transistor configured to generate a driving current for driving the light-emitting device to emit light according to a data voltage; a coupling control circuit configured to stabilize voltages at the first node, and the gate electrode and the second electrode of the driving transistor; a signal writing circuit configured to provide a signal from a data signal terminal to the first node in response to a signal from a scan signal terminal, and to provide a signal from a first power terminal to the first electrode of the driving transistor in response to a signal from a light-emitting control signal terminal; and a threshold compensation circuit configured to write a threshold voltage of the driving transistor to the gate electrode of the driving transistor.

### TECHNICAL FIELD

The present disclosure relates to the field of display technology, and in particular to a pixel circuit, a display panel, a display apparatus, and a driving method for a pixel circuit.

### BACKGROUND

A light-emitting device such as an organic light-emitting diode (OLED), a quantum dot light-emitting diode (QLED), a micro light-emitting diode (micro LED), and a mini light-emitting diodes (mini LED) has the advantages of self-luminous, low energy consumption, and the like, and is one of the hotspots in the field of application and research of a current display apparatus. A pixel circuit is generally used in the display apparatus to drive the light-emitting device to emit light.

### SUMMARY

Embodiments of the present disclosure provide a pixel circuit, including: a light-emitting device; a driving transistor configured to generate a driving current for driving the light-emitting device to emit light according to a data voltage; a coupling control circuit coupled to a first node, and a gate electrode and a second electrode of the driving transistor and configured to stabilize voltages at the first node, and the gate electrode and the second electrode of the driving transistor; a signal writing circuit coupled to the first node and a first electrode of the driving transistor and configured to provide a signal from a data signal terminal to the first node in response to a signal from a scan signal terminal, and to provide a signal from a first power terminal to the first electrode of the driving transistor in response to a signal from a light-emitting control signal terminal; and a threshold compensation circuit coupled to the driving transistor and configured to write a threshold voltage of the driving transistor to the gate electrode of the driving transistor.

In some possible embodiments, the coupling control circuit includes: a first coupling control sub-circuit and a second coupling control sub-circuit; the first coupling control sub-circuit is configured to stabilize the voltage at the gate electrode of the driving transistor and the voltage at the first node; and the second coupling control sub-circuit is configured to stabilize the voltage at the second electrode of the driving transistor and stabilize the voltage at the gate electrode of the driving transistor or the first node.

In some possible embodiments, the first coupling control sub-circuit includes: a first capacitor; and a first plate of the first capacitor is coupled to the gate electrode of the driving transistor, and a second plate of the first capacitor is coupled to the first node.

In some possible embodiments, the second coupling control sub-circuit includes: a second capacitor; and a first plate of the second capacitor is coupled to the second electrode of the driving transistor, and a second plate of the first capacitor is coupled to the gate electrode of the driving transistor or the first node.

In some possible embodiments, the threshold compensation circuit is further configured to initialize the first node and the gate electrode, the first electrode, and the second electrode of the driving transistor.

In some possible embodiments, the threshold compensation circuit includes: a first threshold compensation sub-circuit, a second threshold compensation sub-circuit, and a third threshold compensation sub-circuit; the first threshold compensation sub-circuit is configured to electrically connect the first node to the second electrode of the driving transistor or provide a signal from a first initialization signal terminal to the first node in response to a signal from a first compensation control signal terminal; the second threshold compensation sub-circuit is configured to electrically connect the gate electrode to the first electrode of the driving transistor in response to a signal from a second compensation control signal terminal; and the third threshold compensation sub-circuit is configured to provide a signal from a second initialization signal terminal to the second electrode of the driving transistor in response to a signal from a third compensation control signal terminal.

In some possible embodiments, in each display frame, an active level of the signal from at least one of the first compensation control signal terminal, the second compensation control signal terminal, and the third compensation control signal terminal appears before an active level of the signal from the scan signal terminal.

In some possible embodiments, in each display frame, a sustain duration of the active level of the signal from at least one of the first compensation control signal terminal, the second compensation control signal terminal, and the third compensation control signal terminal is greater than a sustain duration of the active level of the signal from the scan signal terminal.

In some possible embodiments, at least two of the first compensation control signal terminal, the second compensation control signal terminal, and the third compensation control signal terminal are the same signal terminal.

In some possible embodiments, the first threshold compensation sub-circuit includes: a first transistor; and a gate electrode of the first transistor is coupled to the first compensation control signal terminal, a first electrode of the first transistor is coupled to the first node, and a second electrode of the first transistor is coupled to the second electrode of the driving transistor or the first initialization signal terminal.

In some possible embodiments, the second threshold compensation sub-circuit includes: a second transistor; and a gate electrode of the second transistor is coupled to the second compensation control signal terminal, a first electrode of the second transistor is coupled to the gate electrode of the driving transistor, and a second electrode of the second transistor is coupled to the first electrode of the driving transistor.

In some possible embodiments, the third threshold compensation sub-circuit includes: a third transistor; and a gate electrode of the third transistor is coupled to the third compensation control signal terminal, a first electrode of the third transistor is coupled to the second initialization signal terminal, and a second electrode of the third transistor is coupled to the second electrode of the driving transistor.

In some possible embodiments, the signal writing circuit includes: a fourth transistor and a fifth transistor; a gate electrode of the fourth transistor is coupled to the scan signal terminal, a first electrode of the fourth transistor is coupled to the data signal terminal, and a second electrode of the fourth transistor is coupled to the first node; and a gate electrode of the fifth transistor is coupled to the light-emitting control signal terminal, a first electrode of the fifth transistor is coupled to the first power terminal, and a second electrode of the fifth transistor is coupled to the first electrode of the driving transistor.

In some possible embodiments, the pixel circuit further includes: a reset circuit; and the reset circuit is configured to provide a signal from a third initialization signal terminal to the second electrode of the driving transistor in response to a signal from a reset signal terminal.

In some possible embodiments, the reset signal terminal and the scan signal terminal are the same signal terminal.

In some possible embodiments, the reset circuit includes: a sixth transistor; and a gate electrode of the sixth transistor is coupled to the reset signal terminal, a first electrode of the sixth transistor is coupled to the third initialization signal terminal, and a second electrode of the sixth transistor is coupled to the second electrode of the driving transistor.

In some possible embodiments, at least two of the first initialization signal terminal, the second initialization signal terminal, and the third initialization signal terminal are the same signal terminal.

In some possible embodiments, an anode of the light-emitting device is coupled to the second electrode of the driving transistor, and a cathode of the light-emitting device is coupled to a second power terminal; and at least one of the first initialization signal terminal, the second initialization signal terminal and the third initialization signal terminal is the same signal terminal as the second power terminal.

In some possible embodiments, the pixel circuit further includes: an initialization circuit; and the initialization circuit is configured to provide a signal from a fourth initialization signal terminal to the gate electrode of the driving transistor in response to a signal from a fourth compensation control signal terminal.

In some possible embodiments, the initialization circuit includes: a seventh transistor; and a gate electrode of the seventh transistor is coupled to the fourth compensation control signal terminal, a first electrode of the seventh transistor is coupled to the fourth initialization signal terminal, and a second electrode of the seventh transistor is coupled to the gate electrode of the driving transistor.

In some possible embodiments, the fourth initialization signal terminal is the same signal terminal as the first power terminal.

The embodiments of the present disclosure further provide a display panel, including: a plurality of sub-pixels; wherein each of the plurality of sub-pixels includes the above pixel circuit.

In some possible embodiments, the display panel further includes: a plurality of scan signal lines; wherein each of the plurality of scan signal lines is coupled to the scan signal terminals of the pixel circuits in a corresponding row of sub-pixels; a gate driving circuit coupled to the plurality of scan signal lines; wherein the gate driving circuit is configured to input scan signals to the plurality of scan signal lines; a plurality of light-emitting control signal lines; wherein each of the plurality of light-emitting control signal lines is coupled to the light-emitting control signal terminals of the pixel circuits in a corresponding row of sub-pixels; a light-emitting control circuit coupled to the plurality of light-emitting control signal lines; wherein the light-emitting control circuit is configured to input light-emitting control signals to the plurality of light-emitting control signal lines; a plurality of compensation control signal lines; wherein each of the plurality of compensation control signal lines is coupled to the first compensation control signal terminals of the pixel circuits in a corresponding row of sub-pixels; and a compensation control circuit coupled to the plurality of compensation control signal lines; wherein the compensation control circuit is configured to input compensation control signals to the plurality of compensation control signal lines.

In some possible embodiments, each of the plurality of scan signal lines is coupled to the reset signal terminals of the pixel circuits in a corresponding row of sub-pixels; and/or each of the plurality of compensation control signal lines is coupled to the second compensation control signal terminals of the pixel circuits in a corresponding row of sub-pixels; and/or each of the plurality of compensation control signal lines is coupled to the third compensation control signal terminals of the pixel circuits in a corresponding row of sub-pixels.

The embodiments of the present disclosure further provide a display apparatus including the display panel.

The embodiments of the present disclosure further provide a method for driving the pixel circuit, wherein each of a plurality of consecutive display frames includes an initialization stage, a threshold compensation stage, a data writing stage and a luminescent stage, and the method includes: in the initialization stage, providing, by the signal writing circuit, a signal from the first power terminal to the first electrode of the driving transistor in response to a signal from the light-emitting control signal terminal, and stabilizing, by the coupling control circuit, the voltages at the first node, the gate electrode and the second electrode of the driving transistor; in the threshold compensation stage, writing, by the threshold compensation circuit, the threshold voltage of the driving transistor to the gate electrode of the driving transistor, and stabilizing, by the coupling control circuit, the voltages at the first node, the gate electrode and the second electrode of the driving transistor; in the data writing stage, providing, by the signal writing circuit, a signal from the data signal terminal to the first node in response to a signal from the scan signal terminal, and stabilizing, by the coupling control circuit, the voltages at the first node, the gate electrode and the second electrode of the driving transistor; and in the luminescent stage, providing, by the signal writing circuit, a signal from the first power terminal to the first electrode of the driving transistor in response to a signal from the light-emitting control signal terminal, stabilizing, by the coupling control circuit, the voltages at the first node, the gate electrode and the second electrode of the driving transistor, and generating, by the driving transistor, a driving current for driving the light-emitting device to emit light according to the data voltage, to drive the light-emitting device to emit light; wherein in each display frame, the voltage from the first power terminal is a high voltage.

In some possible embodiments, in the initialization stage, the driving method further includes: initializing, by the threshold compensation circuit, the first node and the gate electrode, the first electrode, and the second electrode of the driving transistor.

In some possible embodiments, there is a black frame insertion between any two adjacent ones of at least some of the plurality of display frames, and the method further includes: in the black frame insertion, providing, by the signal writing circuit, a signal from the first power terminal to the first electrode of the driving transistor in response to a signal from the light-emitting control signal terminal; initializing, by the threshold compensation circuit, the first node and the gate electrode, the first electrode, and the second electrode of the driving transistor; and stabilizing, by the coupling control circuit, the voltage at the first node, the gate electrode and the second electrode of the driving transistor; wherein the voltage from the first power terminal is a low voltage.

### BRIEF DESCRIPTION OF DRAWINGS

FIG. 1 is a schematic diagram of a structure of a pixel circuit according to an embodiment of the present disclosure;

FIG. 2 is a schematic diagram of a structure of another pixel circuit according to an embodiment of the present disclosure;

FIG. 3 is a schematic diagram of a specific structure of a pixel circuit according to an embodiment of the present disclosure;

FIG. 4 is a flowchart of a driving method for a pixel circuit according to an embodiment of the present disclosure

FIG. 5 is a timing diagram of signals for a pixel circuit according to an embodiment of the present disclosure;

FIG. 6 is a schematic diagram of a specific structure of another pixel circuit according to an embodiment of the present disclosure;

FIG. 7 is a schematic diagram of a specific structure of another pixel circuit according to an embodiment of the present disclosure;

FIG. 8 is a schematic diagram of a specific structure of another pixel circuit according to an embodiment of the present disclosure;

FIG. 9 is a schematic diagram of a specific structure of another pixel circuit according to an embodiment of the present disclosure;

FIG. 10 is a schematic diagram of a specific structure of another pixel circuit according to an embodiment of the present disclosure;

FIG. 11 is a schematic diagram of a specific structure of another pixel circuit according to an embodiment of the present disclosure;

FIG. 12 is a schematic diagram of a specific structure of another pixel circuit according to an embodiment of the present disclosure;

FIG. 13 is a schematic diagram of a specific structure of another pixel circuit according to an embodiment of the present disclosure;

FIG. 14 is a schematic diagram of a specific structure of another pixel circuit according to an embodiment of the present disclosure;

FIG. 15 is a schematic diagram of a specific structure of another pixel circuit according to an embodiment of the present disclosure;

FIG. 16 is a schematic diagram of a specific structure of another pixel circuit according to an embodiment of the present disclosure;

FIG. 17 is a timing diagram of signals for another pixel circuit according to an embodiment of the present disclosure;

FIG. 18 is a schematic diagram of a specific structure of another pixel circuit according to an embodiment of the present disclosure;

FIG. 19 is a schematic diagram of a specific structure of another pixel circuit according to an embodiment of the present disclosure;

FIG. 20 is a schematic diagram of a specific structure of another pixel circuit according to an embodiment of the present disclosure;

FIG. 21 is a schematic diagram of a specific structure of another pixel circuit according to an embodiment of the present disclosure;

FIG. 22 is a timing diagram of signals for another pixel circuit according to an embodiment of the present disclosure;

FIG. 23 is a schematic diagram of a specific structure of another pixel circuit according to an embodiment of the present disclosure;

FIG. 24 is a timing diagram of signals for another pixel circuit according to an embodiment of the present disclosure;

FIG. 25 is a timing diagram of signals for another pixel circuit according to an embodiment of the present disclosure; and

FIG. 26 is a schematic diagram of a structure of a display apparatus according to an embodiment of the present disclosure.

### DETAIL DESCRIPTION OF EMBODIMENTS

To make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few, not all of, embodiments of the present disclosure. The embodiments and features of the embodiments in the present disclosure may be combined with each other without conflict. All other embodiments, which can be derived by a person skilled in the art from the embodiments of the present disclosure without any creative effort, are within the protective scope of the present disclosure.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. The term “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections.

It should be noted that the sizes and shapes of the various elements in the drawings are not to scale, but are merely intended to schematically illustrate the present disclosure. Like or similar reference numerals refer to like or similar elements or elements having like or similar functions throughout.

A display apparatus provided by the embodiment of the present disclosure includes: a display panel including a plurality of pixel units arranged in an array. Illustratively, each pixel unit includes a plurality of sub-pixels. For example, each pixel unit may include a red sub-pixel, a green sub-pixel, and a blue sub-pixel, so that red, green, and blue colors may be mixed to realize the color display. Alternatively, each pixel unit may also include a red sub-pixel, a green sub-pixel, a blue sub-pixel, and a white sub-pixel, so that red, green, blue, and white colors may be mixed to realize the color display. Alternatively, in practical applications, a light-emitting color of the sub-pixels in the pixel unit may be designed and determined according to practical application environments, and is not limited herein.

In the embodiment of the present disclosure, each sub-pixel includes a pixel circuit, and the pixel circuit includes a driving transistor and a light-emitting device configured to drive the light-emitting device to emit light, so that the display panel realizes a function of displaying a picture. Due to the process and the aging of the device or other factors, a threshold voltage Vth of the driving transistor has non-uniformity, which causes the current flowing through different light-emitting devices to change and the display brightness to be non-uniform, thereby affecting the display effect of the whole image. In addition, in the pixel circuit in the related art, a path for writing a data voltage and a path for compensating the threshold voltage Vth are completely the same, and thus the time for writing the data voltage and the time for compensating the threshold voltage Vth are completely the same. However, the time required for sufficiently compensating the threshold voltage Vth is long, so that a duration for an active level of a signal for controlling the writing of the data voltage is prolonged, which cannot realize high-frequency driving.

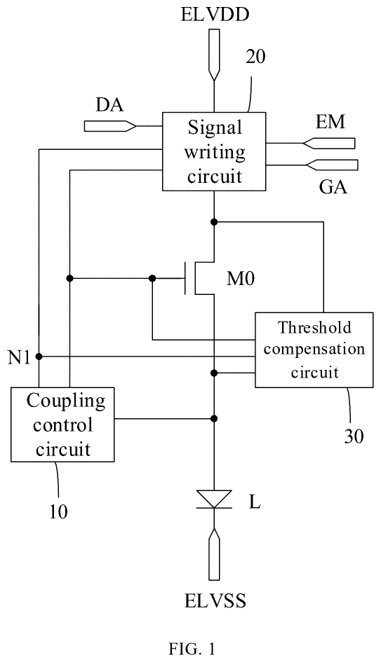

Based on this, as shown in FIG. 1, a pixel circuit provided by the embodiment of the present disclosure includes: a light-emitting device L, a driving transistor M0, a coupling control circuit 10, a signal writing circuit 20, and a threshold compensation circuit 30. The coupling control circuit 10 is coupled to a first node N1, and a gate electrode and a second electrode of the driving transistor M0. The signal writing circuit is coupled to the first node N1 and a first electrode of the driving transistor M0. The threshold compensation circuit 30 is coupled to the driving transistor M0.

The driving transistor M0 is configured to generate a current for driving the light-emitting device L to emit light according to a data voltage.

The coupling control circuit 10 is configured to stabilize voltages at the first node N1, and the gate electrode and the second electrode of the driving transistor M0.

The signal writing circuit 20 is configured to provide a signal from a data signal terminal DA to the first node N1 in response to a signal from a scan signal terminal GA, and to provide a signal from a first power terminal ELVDD to the first electrode of the driving transistor M0 in response to a signal from a light-emitting control signal terminal EM.

The threshold compensation circuit 30 is configured to write the threshold voltage of the driving transistor M0 to the gate electrode of the driving transistor M0.

In the pixel circuit provided by the embodiment of the present disclosure, the influence of drifting of the threshold voltage of the driving transistor on the light-emitting of the light-emitting device can be avoided through mutual cooperation of the coupling control circuit, the signal writing circuit, the threshold compensation circuit and the driving transistor.

In the pixel circuit provided by the embodiment of the present disclosure, the path for compensating the threshold voltage of the driving transistor is different from the path for writing the data voltage through the mutual cooperation of the coupling control circuit, the signal writing circuit, the threshold compensation circuit and the driving transistor. Therefore, the process for compensating the threshold voltage of the driving transistor and the process for writing the data voltage are separately performed, and the high-frequency driving can be realized. In addition, the process for compensating the threshold voltage of the driving transistor and the process for writing the data voltage are separately performed, the process for compensating the threshold voltage may be performed for a long time, which can be ensured that the threshold voltage of the driving transistor is compensated better, so that a driving frequency (such as 120 Hz, 180 Hz or 240 Hz) can be improved, the effect of the field scenes such as games and the like can be advantageously improved, the precision of the driving current can be improved, the display quality is improved, the light-emitting stability is further improved, and the display effect of the display panel is improved.

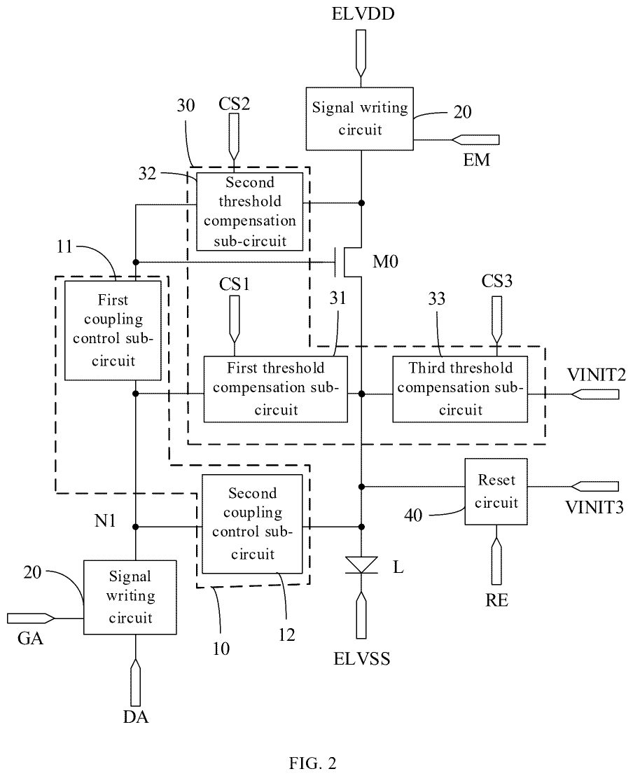

In some embodiments of the present disclosure, as shown in FIG. 2, the coupling control circuit 10 may include: a first coupling control sub-circuit 11 and a second coupling control sub-circuit 12. The first coupling control sub-circuit 11 is configured to stabilize the voltage at the gate electrode of the driving transistor M0 and stabilize the voltage at the first node N1. The second coupling control sub-circuit 12 is configured to stabilize the voltage at the second electrode of the driving transistor M0, and to stabilize the voltage at the first node N1. In this way, the voltage at the first node N1, and the gate electrode and the second electrode of the driving transistor M0 can be stabilized through the mutual cooperation of the first coupling control sub-circuit 11 and the second coupling control sub-circuit 12.

In some embodiments of the present disclosure, as shown in FIG. 2, the threshold compensation circuit 30 includes: a first threshold compensation sub-circuit 31, a second threshold compensation sub-circuit 32, and a third threshold compensation sub-circuit 33. The first threshold compensation sub-circuit 31 is configured to electrically connect the first node N1 to the second electrode of the driving transistor M0 or to provide a signal from a first initialization signal terminal VINIT1 to the first node N1 in response to a signal from a first compensation control signal terminal CS1. The second threshold compensation sub-circuit 32 is configured to electrically connect the gate electrode of the driving transistor M0 to the first electrode of the driving transistor M0 in response to a signal from a second compensation control signal terminal CS2. The third threshold compensation sub-circuit 33 is configured to provide a signal from a second initialization signal terminal VINIT2 to the second electrode of the driving transistor M0 in response to a signal from a third compensation control signal terminal CS3.

In some embodiments of the present disclosure, as shown in FIG. 2, the pixel circuit further includes: a reset circuit 40; wherein the reset circuit 40 is configured to provide a signal from a third initialization signal terminal VINIT3 to the second electrode of the driving transistor M0 in response to a signal from a reset signal terminal RE.

The present disclosure is described in detail below with reference to specific embodiments. It should be noted that the present embodiment is used to better explain, not limit, the present disclosure.

In the embodiment of the present disclosure, as shown in FIG. 1 and FIG. 2, the driving transistor M0 may be configured as an N-type transistor. The first electrode of the driving transistor M0 may be a source electrode of the driving transistor M0, and the second electrode of the driving transistor M0 may be a drain electrode of the driving transistor M0. Alternatively, the driving transistor M0 may be configured as a P-type transistor, which is not limited herein.

In the embodiment of the present disclosure, as shown in FIGS. 1 and 2, the second electrode of the driving transistor M0 is coupled to an anode of the light-emitting device L, and a cathode of the light-emitting device L is coupled to a second power terminal ELVSS. Illustratively, the light-emitting device L may include: at least one of a micro light-emitting diode (a micro LED), an organic light-emitting diode (OLED), and a quantum dot light-emitting diode (QLED). Illustratively, the light-emitting device L may include an anode, a light-emitting layer, and a cathode, which are stacked. Further, the light-emitting layer may include a hole injection layer, a hole transport layer, an electron transport layer, an electron injection layer, and the like. In practical applications, the specific structure of the light-emitting device L may be designed and determined according to practical application environments, which is not limited herein.

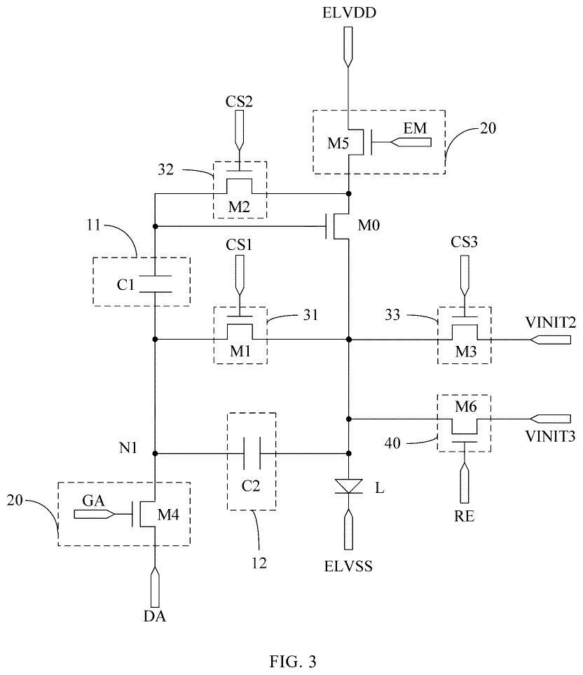

In some embodiments of the present disclosure, as shown in FIG. 3, the first coupling control sub-circuit 11 includes: a first capacitor C1, a first plate of the first capacitor C1 is coupled to the gate electrode of the driving transistor M0, and a second plate of the first capacitor C1 is coupled to the first node N1.

In some embodiments of the present disclosure, as shown in FIG. 3, the second coupling control sub-circuit 12 includes: a second capacitor C2, a first plate of the second capacitor C2 is coupled to the second electrode of the driving transistor M0, and a second plate of the first capacitor C1 is coupled to the first node N1.

In some embodiments of the present disclosure, as shown in FIG. 3, the first threshold compensation sub-circuit 31 includes: a first transistor M1, a gate electrode of the first transistor M1 is coupled to the first compensation control signal terminal CS1, a first electrode of the first transistor M1 is coupled to the first node N1, and a second electrode of the first transistor M1 is coupled to the second electrode of the driving transistor M0.

Illustratively, the first transistor M1 is turned on under the control of an active level of a first compensation control signal from the first compensation control signal terminal CS1 and turned off under the control of an inactive level of the first compensation control signal. Optionally, the first transistor M1 may be an N-type transistor, and the active level of the first compensation control signal is high and the inactive level is low. Alternatively, the first transistor M1 may be a P-type transistor, and the active level of the first compensation control signal is low and the inactive level is high.

In some embodiments of the present disclosure, as shown in FIG. 3, the second threshold compensation sub-circuit 32 includes: a second transistor M2, a gate electrode of the second transistor M2 is coupled to a second compensation control signal terminal CS2, a first electrode of the second transistor M2 is coupled to the gate electrode of the driving transistor M0, and a second electrode of the second transistor M2 is coupled to the first electrode of the driving transistor M0.

Illustratively, the second transistor M2 is turned on under the control of an active level of a second compensation control signal from the second compensation control signal terminal CS2 and turned off under the control of an inactive level of the second compensation control signal. Optionally, the second transistor M2 may be an N-type transistor, and the active level of the second compensation control signal is high and the inactive level is low. Alternatively, the second transistor M2 may be a P-type transistor, and the active level of the second compensation control signal is low and the inactive level is high.

In some embodiments of the present disclosure, as shown in FIG. 3, the third threshold compensation sub-circuit 33 includes: a third transistor M3, a gate electrode of the third transistor M3 is coupled to a third compensation control signal terminal CS3, a first electrode of the third transistor M3 is coupled to the second initialization signal terminal VINIT2, and a second electrode of the second transistor M2 is coupled to the second electrode of the driving transistor M0.

Illustratively, the third transistor M3 is turned on under the control of an active level of a third compensation control signal from the third compensation control signal terminal CS3 and turned off under the control of an inactive level of the third compensation control signal. Optionally, the third transistor M3 may be an N-type transistor, and the active level of the third compensation control signal is high and the inactive level is low. Alternatively, the third transistor M3 may be a P-type transistor, and the active level of the third compensation control signal is low and the inactive level is high.

In some embodiments of the present disclosure, as shown in FIG. 3, the signal writing circuit 20 includes: a fourth transistor M4 and a fifth transistor M5, a gate electrode of the fourth transistor M4 is coupled to the scan signal terminal GA, a first electrode of the fourth transistor M4 is coupled to the data signal terminal DA, and a second electrode of the fourth transistor M4 is coupled to the first node N1. A gate electrode of the fifth transistor M5 is coupled to the light-emitting control signal terminal EM, a first electrode of the fifth transistor M5 is coupled to the first power terminal ELVDD, and a second electrode of the fifth transistor M5 is coupled to the first electrode of the driving transistor M0.

Illustratively, the fourth transistor M4 is turned on under the control of an active level of a scan signal from the scan signal terminal GA and turned off under the control of an inactive level of the scan signal. Optionally, the fourth transistor M4 may be an N-type transistor, and the active level of the scan signal is high and the inactive level is low. Alternatively, the fourth transistor M4 may be a P-type transistor, and the active level of the scan signal is low and the inactive level is high.

Illustratively, the fifth transistor M5 is turned on under the control of an active level of a light-emitting control signal from the light-emitting control signal terminal EM and turned off under the control of an inactive level of the light-emitting control signal. Optionally, the fifth transistor M5 may be an N-type transistor, and the active level of the light-emitting control signal is high and the inactive level is low. Alternatively, the fifth transistor M5 may be a P-type transistor, and the active level of the light-emitting control signal is low and the inactive level is high.

In some embodiments of the present disclosure, as shown in FIG. 3, the reset circuit 40 includes: a sixth transistor M6, a gate electrode of the sixth transistor M6 is coupled to the reset signal terminal RE, a first electrode of the sixth transistor M6 is coupled to the third initialization signal terminal VINIT3, and a second electrode of the sixth transistor M6 is coupled to the second electrode of the driving transistor M0.

Illustratively, the sixth transistor M6 is turned on under the control of an active level of a reset signal from the reset signal terminal RE and turned off under the control of an inactive level of the reset signal. Optionally, the sixth transistor M6 may be an N-type transistor, and the active level of the reset signal is high and the inactive level is low. Alternatively, the sixth transistor M6 may be a P-type transistor, and the active level of the reset signal is low and the inactive level is high.

For example, the first electrode of the transistor may be a source electrode thereof, and the second electrode may be a drain electrode thereof. Alternatively, the first electrode is the drain electrode and the second electrode is the source electrode, which is not limited here.

Generally, a transistor with an active layer made of a low temperature poly-silicon (LTPS) material has a high mobility, and may be made thinner and smaller, and has lower power consumption, and other advantages. In specific implementation, the active layer of the at least one transistor may be made of the low temperature poly-silicon (LTPS) material. In this way, the above transistor may be an LTPS transistor, so that the pixel circuit has a high mobility and may be made thinner and smaller, and has lower power consumption, and other advantages.

Generally, a transistor with an active layer made of a metal oxide semiconductor materials have a lower leakage current. Therefore, in order to reduce the leakage current, in some embodiments of the present disclosure, the material of the active layer of the at least one transistor may also include the metal oxide semiconductor material, such as IGZO (indium gallium zinc oxide). Alternatively, other metal oxide semiconductor materials may be used, which is not limited herein. In this way, the above transistor may be an oxide thin film transistor so that the leak current of the pixel circuit is reduced.

Illustratively, all the transistors may be the LTPS transistors. Alternatively, all the transistors may be the oxide thin film transistors. Alternatively, a part of the transistors may be the oxide thin film transistors and the remaining transistors may be the LTPS transistors. For example, the first transistor, the second transistor, and the fourth transistor may be the oxide thin film transistors, and the remaining transistors may be the LTPS transistors.

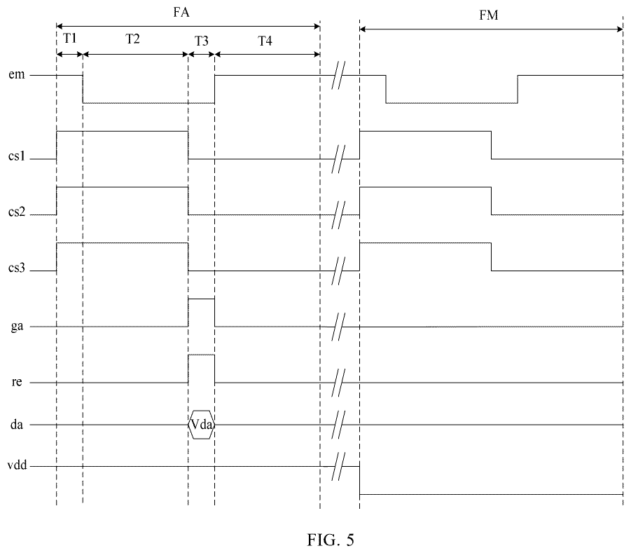

In some embodiments of the present disclosure, in each display frame, an active level of the signal from the first compensation control signal terminal CS1 may appear before an active level of the signal from the scan signal terminal GA. That is, the active level of the first compensation control signal appears firstly and then the active level of the scan signal appears. For example, as shown in FIG. 5, cs1 represents the first compensation control signal from the first compensation control signal terminal CS1, and ga represents the scan signal from the scan signal terminal GA. Taking the active level as the high level as an example, the high level of the first compensation control signal cs1 appears before the high level of the scan signal ga in each display frame.

In some embodiments of the present disclosure, in each display frame, an end time of the active level of the signal from the first compensation control signal terminal CS1 may be the same as a start time of the active level of the signal from the scan signal terminal GA. For example, as shown in FIG. 5, taking the active level as the high level as an example, the end time of the high level of the first compensation control signal cs1 is the same as the start time of the high level of the scan signal ga in each display frame.

In some embodiments of the present disclosure, in each display frame, there may alternatively be an interval duration between the end time of the active level of the signal from the first compensation control signal terminal and the start time of the active level of the signal from the scan signal terminal. Taking the active level as the high level as an example, in each display frame, since the end time of the high level of the first compensation control signal, the start time of the high level of the scan signal will appear after the interval duration has elapsed. In practical applications, the interval duration may be determined according to requirements of practical applications, which is not limited herein.

In some embodiments of the present disclosure, in each display frame, a sustain duration of the active level of the signal from the first compensation control signal terminal CS1 may be greater than a sustain duration of the active level of the signal from the scan signal terminal GA. For example, as shown in FIG. 5, taking the active level as the high level as an example, in each display frame, the sustain duration tcs of the high level of the first compensation control signal cs1 is greater than the sustain duration tga of the high level of the scan signal ga.

In some embodiments of the present disclosure, in each display frame, an active level of the signal from the second compensation control signal terminal CS2 may appear before an active level of the signal from the scan signal terminal GA. That is, the active level of the second compensation control signal appears firstly and then the active level of the scan signal appears. For example, as shown in FIG. 5, cs2 represents the second compensation control signal from the second compensation control signal terminal CS2, and ga represents the scan signal from the scan signal terminal GA. Taking the active level as the high level as an example, the high level of the second compensation control signal cs2 appears before the high level of the scan signal ga in each display frame.

In some embodiments of the present disclosure, in each display frame, an end time of the active level of the signal from the second compensation control signal terminal CS2 may be the same as a start time of the active level of the signal from the scan signal terminal GA. For example, as shown in FIG. 5, taking the active level as the high level as an example, the end time of the high level of the second compensation control signal cs2 is the same as the start time of the high level of the scan signal ga in each display frame.

In some embodiments of the present disclosure, in each display frame, there may alternatively be an interval duration between the end time of the active level of the signal from the second compensation control signal terminal and the start time of the active level of the signal from the scan signal terminal. Taking the active level as the high level as an example, in each display frame, since the end time of the high level of the second compensation control signal, the start time of the high level of the scan signal will appear after the interval duration has elapsed. In practical applications, the interval duration may be determined according to requirements of practical applications, which is not limited herein.

In some embodiments of the present disclosure, in each display frame, a sustain duration of the active level of the signal from the second compensation control signal terminal CS2 may be greater than a sustain duration of the active level of the signal from the scan signal terminal GA. For example, as shown in FIG. 5, taking the active level as the high level as an example, in each display frame, the sustain duration tcs of the high level of the second compensation control signal cs2 is greater than the sustain duration tga of the high level of the scan signal ga.

In some embodiments of the present disclosure, in each display frame, an active level of the signal from the third compensation control signal terminal CS3 may appear before an active level of the signal from the scan signal terminal GA. That is, the active level of the third compensation control signal appears firstly and then the active level of the scan signal appears. For example, as shown in FIG. 5, cs3 represents the third compensation control signal from the third compensation control signal terminal CS3, and ga represents the scan signal from the scan signal terminal GA. Taking the active level as the high level as an example, the high level of the third compensation control signal cs3 appears before the high level of the scan signal ga in each display frame.

In some embodiments of the present disclosure, in each display frame, an end time of the active level of the signal from the third compensation control signal terminal CS3 may be the same as a start time of the active level of the signal from the scan signal terminal GA. For example, as shown in FIG. 5, taking the active level as the high level as an example, the end time of the high level of the third compensation control signal cs3 is the same as the start time of the high level of the scan signal ga in each display frame.

In some embodiments of the present disclosure, in each display frame, there may alternatively be an interval duration between the end time of the active level of the signal from the third compensation control signal terminal and the start time of the active level of the signal from the scan signal terminal. Taking the active level as the high level as an example, in each display frame, since the end time of the high level of the third compensation control signal, the start time of the high level of the scan signal will appear after the interval duration has elapsed. In practical applications, the interval duration may be determined according to requirements of practical applications, which is not limited herein.

In some embodiments of the present disclosure, in each display frame, a sustain duration of the active level of the signal from the third compensation control signal terminal CS3 may be greater than a sustain duration of the active level of the signal from the scan signal terminal GA. For example, as shown in FIG. 5, taking the active level as the high level as an example, in each display frame, the sustain duration tcs of the high level of the third compensation control signal cs3 is greater than the sustain duration tga of the high level of the scan signal ga.

In some embodiments of the present disclosure, the first compensation control signal cs1, the second compensation control signal cs2, and the third compensation control signal cs3 may be the same.

The embodiment of the present disclosure provides a method for driving a pixel circuit. Each of a plurality of consecutive display frames includes an initialization stage, a threshold compensation stage, a data writing stage and a luminescent stage.

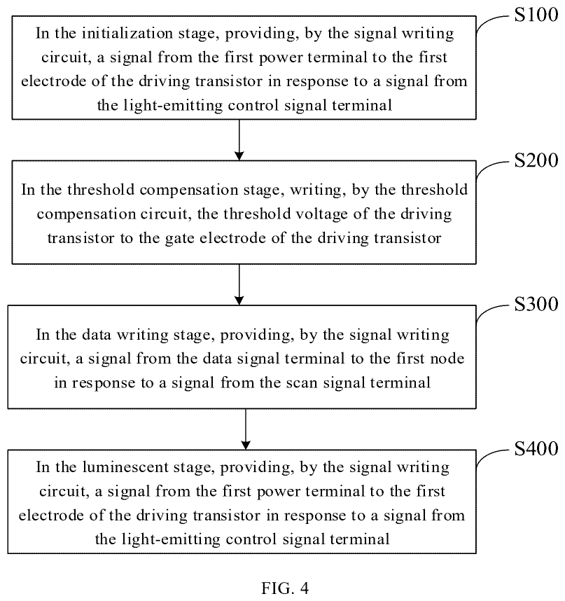

Illustratively, as shown in FIG. 4, an operating process of the pixel circuit provided by the embodiment of the present disclosure in each display frame includes the following steps S100 to S400.

The step S100 includes, in the initialization stage, providing, by the signal writing circuit, a signal from the first power terminal to the first electrode of the driving transistor in response to a signal from the light-emitting control signal terminal, and stabilizing, by the coupling control circuit, the voltages at the first node, the gate electrode and the second electrode of the driving transistor.

The step S200 includes, in the threshold compensation stage, writing, by the threshold compensation circuit, the threshold voltage of the driving transistor to the gate electrode of the driving transistor, and stabilizing, by the coupling control circuit, the voltages at the first node, the gate electrode and the second electrode of the driving transistor.

The step S300 includes, in the data writing stage, providing, by the signal writing circuit, a signal from the data signal terminal to the first node in response to a signal from the scan signal terminal, and stabilizing, by the coupling control circuit, the voltages at the first node, the gate electrode and the second electrode of the driving transistor.

The step S400 includes, in the luminescent stage, providing, by the signal writing circuit, a signal from the first power terminal to the first electrode of the driving transistor in response to a signal from the light-emitting control signal terminal, stabilizing, by the coupling control circuit, the voltages at the first node, the gate electrode and the second electrode of the driving transistor, and generating, by the driving transistor, a driving current for driving the light-emitting device to emit light according to the data voltage, to drive the light-emitting device to emit light.

In the embodiment of the present disclosure, the first power terminal ELVDD may be configured to be loaded with a constant high voltage Vdd with generally a positive value in each display frame. The second power terminal ELVSS may be loaded with a constant low voltage Vss, which may be generally a ground voltage or a negative value. In practical applications, specific values of the high voltage Vdd and the low voltage Vss may be determined according to practical application environments, which is not limited herein.

In an embodiment of the present disclosure, the method further includes: in the initialization stage, initializing, by the threshold compensation circuit, the first node and the gate electrode, the first electrode, and the second electrode of the driving transistor.

In an embodiment of the present disclosure, the method further includes: in the data writing stage, providing, by the reset circuit, a signal from the third initialization signal terminal to the second electrode of the driving transistor in response to a signal from the reset signal terminal.

An operating process of the pixel circuit provided in the embodiment of the present disclosure will be described by taking the pixel driving circuit shown in FIG. 3 as an example and combining a timing diagram of signals shown in FIG. 5.

In the embodiment of the present disclosure, as shown in FIG. 5, em represents the light-emitting control signal from the light-emitting control signal terminal EM, cs1 represents the first compensation control signal from the first compensation control signal terminal CS1, cs2 represents the second compensation control signal from the second compensation control signal terminal CS2, cs3 represents the third compensation control signal from the third compensation control signal terminal CS3, re represents the reset signal from the reset signal terminal RE, ga represents the scan signal from the scan signal terminal GA, da represents the data voltage signal from the data signal terminal DA, and vdd represents a signal from the first power terminal ELVDD.

The initialization stage T1, the threshold compensation stage T2, the data writing stage T3, and the luminescent stage T4 in any one display frame FA are selected.

In the initialization stage T1, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The turned-on fifth transistor M5 inputs a voltage from the first power terminal ELVDD to the first electrode of the driving transistor M0 to initialize the first electrode of the driving transistor M0. The turned-on second transistor M2 electrically connects the gate electrode with the first electrode of the driving transistor M0, so that a voltage VM0g at the gate electrode of the driving transistor M0 is the voltage Vdd from the first power terminal ELVDD, i.e., VM0g=Vdd, thereby initializing the gate electrode of the driving transistor M0. The turned-on third transistor M3 provides the second initialization signal from the second initialization signal terminal VINIT2 to the second electrode of the driving transistor M0, so that a voltage VM0s at the second electrode of the driving transistor M0 is a voltage Vint2 of the second initialization signal, that is, VM0s=Vint2, thereby initializing the second electrode of the driving transistor M0 and the anode of the light-emitting device L. The turned-on first transistor M1 electrically connects the second electrode of the driving transistor M0 with the first node N1, so that a voltage VN0 at the first node N1 is the voltage Vint2 of the second initialization signal, that is, VN0=Vint2, thereby initializing the first node N1.

In the threshold compensation stage T2, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned off under the control of the low level of the light-emitting control signal, and the sixth transistor M6 is turned off under the control of the low level of the reset signal. The turned-on third transistor M3 provides the second initialization signal from the second initialization signal terminal VINIT2 to the second electrode of the driving transistor M0, so that the voltage VM0s at the second electrode of the driving transistor M0 is the voltage Vint2 of the second initialization signal, i.e., VM0s=Vint2. The turned-on first transistor M1 electrically connects the second electrode of the driving transistor M0 with the first node N1, so that the voltage VN0 at the first node N1 is the voltage Vinit2 of the second initialization signal, i.e., VN0=Vinit2. The turned-on second transistor M2 electrically connects the gate electrode with the first electrode of the driving transistor M0, so that the driving transistor M0 is in a diode connection mode. The voltage at the gate electrode of the driving transistor M0 is discharged through a path formed by the second transistor M2, the driving transistor M0 and the third transistor M3 to the second initialization signal terminal VINIT2, and decreases continuously from Vdd until VM0g=Vint2+Vth, thereby completing the compensation of the threshold voltage. Then, the driving transistor M0 is turned off.

In the data writing stage T3, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned on under the control of the high level of the scan signal, the fifth transistor M5 is turned off under the control of the low level of the light-emitting control signal, and the sixth transistor M6 is turned on under the control of the high level of the reset signal. The turned-on sixth transistor M6 provides the third initialization signal from the third initialization signal terminal VINIT3 to the second electrode of the driving transistor M0, so that the voltage VM0s at the second electrode of the driving transistor M0 is a voltage Vint3 of the third initialization signal, i.e., VM0s=Vint3. The turned-on fourth transistor M4 inputs the data voltage Vda from the data signal terminal DA to the first node N1, so that VN0=Vda. Since the gate electrode of the driving transistor M0 is in a floating state, a variation of the voltage at the gate electrode of the driving transistor M0 is equal to a variation of the voltage at the first node N1, so that VM0g=Vth+Vda. A voltage difference between the second electrode and the gate electrode of the driving transistor M0 is: Vth+Vda−Vint3.

In the luminescent stage T4, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The first capacitor C1 and the second capacitor C2 are connected in series to form a new capacitor, and the voltages at the gate electrode of the driving transistor M0 and the first node are in a floating state. Since the fifth transistor M5 is turned on, the high voltage signal from the first power terminal ELVDD is input to the first electrode of the driving transistor M0, and the driving transistor M0 generates a driving current. The driving current flows through the driving transistor M0 to charge the anode of the light-emitting device L, and gradually raises VM0s to Vss+Voled, where Voled is a voltage difference between the cathode and the anode when the light-emitting device L is emitting light. Due to the coupling effect of the first capacitor C1 and the second capacitor C2, a variation of VM0s may be coupled to the gate electrode of the driving transistor M0, and a variation of the voltage at the gate electrode of the driving transistor M0 is Vss+Voled-Vint3, so that VM0g=Vth+Vda+Vss+Voled−Vint3. Thus, a voltage difference Vgs between the gate electrode and the source electrode of the driving transistor M0 is Vth+Vda−Vint3. Thus, the driving transistor M0 operates in a saturation region, and the driving current I generated by the driving transistor M0 may be expressed as: I=K×(Vgs−Vth)²=K×(Vda−Vint3)². Where K=1/2*μ*Cox*W/L, μ is a mobility of the driving transistor M0, Cox is a capacitance of a gate insulating layer, and W/L is a width-to-length ratio of a channel of the driving transistor M0.

As can be seen from the above description, the driving current I is not related to the threshold voltage Vth of the driving transistor M0, the second power voltage Vss from the second power terminal ELVSS, and the Voled of the light-emitting device L, and thus the pixel circuit can solve the problem of non-uniform compensation of the threshold voltage of the driving transistor M0, the problem of a voltage drop of the second power voltage from the second power terminal ELVSS, and the problem of non-uniform display caused by aging of the light-emitting device L, thereby improving the display effect.

The process for compensating the threshold voltage is realized in the threshold compensation stage T2. The writing process of the data voltage is realized in the data writing stage T3, and the data voltage is coupled to the gate electrode of the driving transistor M0 based on the coupling effect of the first capacitor C1. In the luminescent stage T4, the first capacitor C1 and the second capacitor C2 are connected in series to form the new capacitor, which is beneficial to bootstrapping of the capacitor.

The path for compensating the threshold voltage of the driving transistor M0 is different from the path for writing the data voltage, and the compensation of the threshold voltage of the driving transistor M0 and the writing of the data voltage are also performed in different time, so that the compensation of the threshold voltage of the driving transistor M0 and the writing of the data voltage can be separately performed, and the high-frequency driving can be realized and the influence of the drifting of the threshold voltage of the driving transistor M0 on the light-emitting of the light-emitting device L can be avoided.

The process for compensating the threshold voltage of the driving transistor M0 and the process for writing the data voltage are separated from each other, the process for compensating the threshold voltage may be performed for a longer time, so as to ensure that the threshold voltage of the driving transistor M0 is compensated better, so that a driving frequency (such as 120 Hz, 180 Hz or 240 Hz) can be improved, the effect of the field scenes such as games and the like can be advantageously improved, the precision of the driving current can be improved, the display quality is improved, the light-emitting stability is further improved, and the display effect of the display panel is improved.

Further, there is a black frame insertion between any two adjacent ones of at least some of the plurality of display frames. The driving method further includes: in the black frame insertion, providing, by the signal writing circuit 20, the signal from the first power terminal ELVDD to the first electrode of the driving transistor M0 in response to the signal from the light-emitting control signal terminal EM; initializing, by the threshold compensation circuit 30, the first node N1 and the gate electrode, the first electrode, and the second electrode of the driving transistor M0; stabilizing, by the coupling control circuit, the voltage at the first node, the gate electrode and the second electrode of the driving transistor; wherein the voltage from the first power terminal ELVDD is a low voltage. For example, as shown in FIG. 5, FM represents the black frame insertion. In the black frame insertion FM, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The turned-on fifth transistor M5 inputs the voltage from the first power terminal ELVDD to the first electrode of the driving transistor M0 to initialize the first electrode of the driving transistor M0. The turned-on second transistor M2 electrically connects the gate electrode with the first electrode of the driving transistor M0, so that the voltage VM0g at the gate electrode of the driving transistor M0 is the low voltage Vdd at the first power terminal ELVDD, i.e., VM0g=Vdd′, thereby initializing the gate electrode of the driving transistor M0. The turned-on third transistor M3 provides the second initialization signal from the second initialization signal terminal VINIT2 to the second electrode of the driving transistor M0, so that the voltage VM0s at the second electrode of the driving transistor M0 is the voltage Vint2 of the second initialization signal, that is, VM0s=Vint2, thereby initializing the second electrode of the driving transistor M0 and the anode of the light-emitting device L. The turned-on first transistor M1 electrically connects the second electrode of the driving transistor M0 and the first node N1, so that the voltage VN0 at the first node N1 is the voltage Vint2 of the second initialization signal, that is, VN0=Vint2, thereby initializing the first node N1.

The low voltage Vdd′ from the first power terminal ELVDD may control the driving transistor M0 to be turned off, so that the operation of threshold compensation is not performed. In addition, in the black frame insertion, the high level of the scan signal is not output, and the data voltage is not output, so that the power consumption can be reduced.

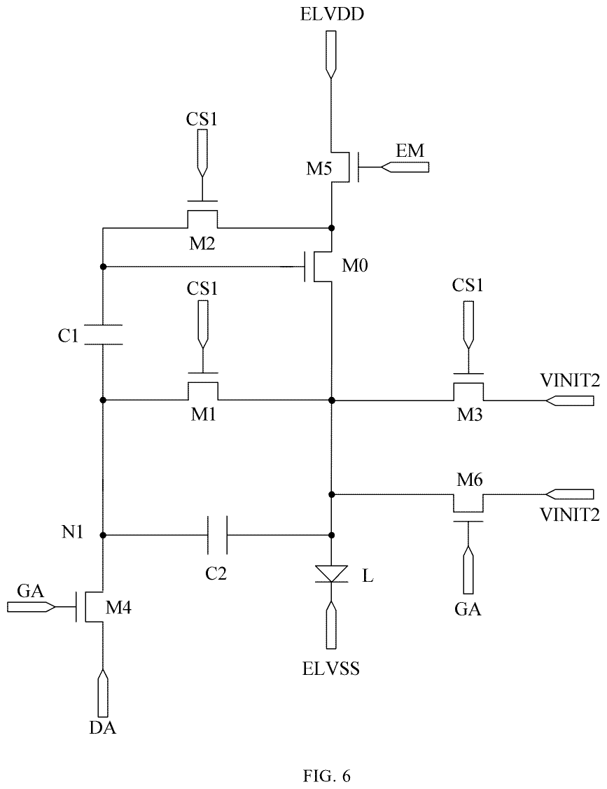

The embodiments of the present disclosure provide some other structures of the pixel circuit, as shown in FIG. 6, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 6, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 6, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal. For example, as shown in FIG. 6, the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 6 may be as shown in FIG. 5. In addition, the specific operating process of the pixel circuit shown in FIG. 6 in combination with the timing diagram of signals shown in FIG. 5 may refer to the description of the above embodiments, and is not repeated herein.

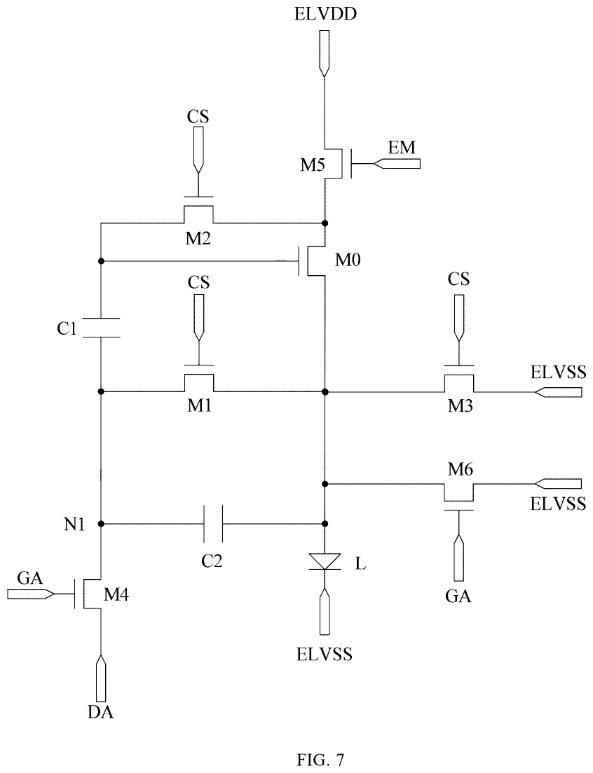

In the embodiments of the present disclosure, FIG. 7 is a schematic diagram of other structure of the pixel circuit, as shown in FIG. 7, which is modification for the implementation of the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 7, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 7, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal as the second power terminal ELVSS. For example, as shown in FIG. 7, the first electrode of the sixth transistor M6 is coupled to the second power terminal ELVSS, and the first electrode of the third transistor M3 is coupled to the second power terminal ELVSS. Therefore, the number of signal lines can be reduced, and the wiring difficulty is reduced.

The timing diagram of the signals corresponding to the pixel circuit shown in FIG. 7 may be as shown in FIG. 5. In addition, the specific operating process of the pixel circuit shown in FIG. 7 in combination with the timing diagram of signals shown in FIG. 5 may refer to the description of the above embodiment, and is not repeated herein.

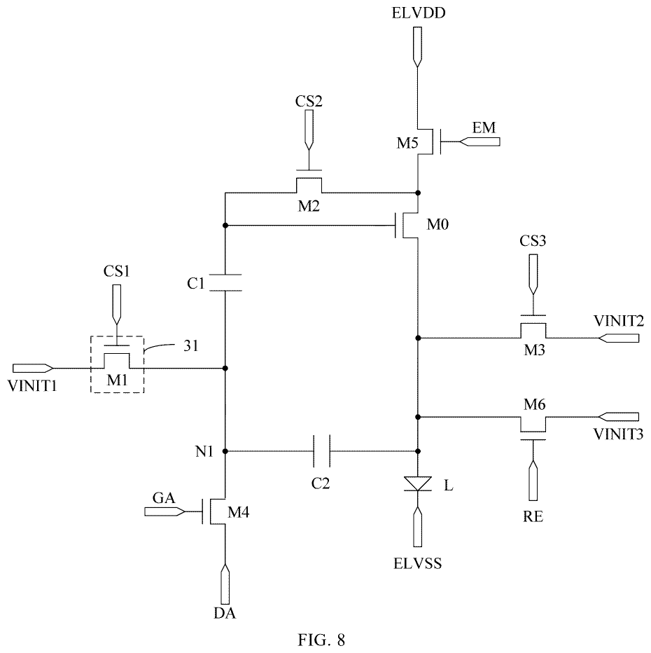

In the embodiments of the present disclosure, FIG. 8 is a schematic diagram of other structure of the pixel circuit, as shown in FIG. 8, which is modification for the implementation of the foregoing embodiments. Only the differences between the present embodiment and the above embodiments will be described below, and the parts that are substantially the same will not be described herein again.

In the embodiment of the present disclosure, as shown in FIG. 8, the first threshold compensation sub-circuit 31 may be configured to provide the signal from the first initialization signal terminal VINIT1 to the first node N1 in response to the signal from the first compensation control signal terminal CS1.

In the embodiment of the present disclosure, as shown in FIG. 8, the second electrode of the first transistor M1 is coupled to the first initialization signal terminal VINIT1.

The timing diagram of the signals corresponding to the pixel circuit shown in FIG. 8 may be as shown in FIG. 5.

In the initialization stage T1, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The turned-on fifth transistor M5 inputs a voltage from the first power terminal ELVDD to the first electrode of the driving transistor M0 to initialize the first electrode of the driving transistor M0. The turned-on second transistor M2 electrically connects the gate electrode with the first electrode of the driving transistor M0, so that a voltage VM0g at the gate electrode of the driving transistor M0 is the voltage Vdd from the first power terminal ELVDD, i.e., VM0g=Vdd, thereby initializing the gate electrode of the driving transistor M0. The turned-on third transistor M3 provides the second initialization signal from the second initialization signal terminal VINIT2 to the second electrode of the driving transistor M0, so that a voltage VM0s at the second electrode of the driving transistor M0 is a voltage Vint2 of the second initialization signal, that is, VM0s=Vint2, thereby initializing the second electrode of the driving transistor M0 and the anode of the light-emitting device L. The turned-on first transistor M1 provides a first initialization signal from the first initialization signal terminal VINIT1 to the first node N1, so that the voltage VN0 at the first node N1 is a voltage Vint1 of the first initialization signal, that is, VN0=Vint1, thereby initializing the first node N1.

In the threshold compensation stage T2, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned off under the control of the low level of the light-emitting control signal, and the sixth transistor M6 is turned off under the control of the low level of the reset signal. The turned-on third transistor M3 provides the second initialization signal from the second initialization signal terminal VINIT2 to the second electrode of the driving transistor M0, so that the voltage VM0s at the second electrode of the driving transistor M0 is the voltage Vint2 of the second initialization signal, i.e., VM0s=Vint2. The turned-on first transistor M1 provides the first initialization signal from the first initialization signal terminal VINIT1 to the first node N1, so that VN0=Vint1. The turned-on second transistor M2 electrically connects the gate electrode with the first electrode of the driving transistor M0, so that the driving transistor M0 is in a diode connection mode. The voltage at the gate electrode of the driving transistor M0 is discharged through a path formed by the second transistor M2, the driving transistor M0 and the third transistor M3 to the second initialization signal terminal VINIT2, and decreases continuously from Vdd until VM0g=Vint2+Vth, thereby completing the compensation of the threshold voltage. Then, the driving transistor M0 is turned off.

In the data writing stage T3, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned on under the control of the high level of the scan signal, the fifth transistor M5 is turned off under the control of the low level of the light-emitting control signal, and the sixth transistor M6 is turned on under the control of the high level of the reset signal. The turned-on sixth transistor M6 provides the third initialization signal from the third initialization signal terminal VINIT3 to the second electrode of the driving transistor M0, so that the voltage VM0s at the second electrode of the driving transistor M0 is a voltage Vint3 of the third initialization signal, i.e., VM0s=Vint3. The turned-on fourth transistor M4 inputs the data voltage Vda from the data signal terminal DA to the first node N1, so that VN0=Vda. Since the gate electrode of the driving transistor M0 is in a floating state, a variation of the voltage at the gate electrode of the driving transistor M0 is equal to a variation of the voltage at the first node N1, so that VM0g=Vint2+Vth+Vda−Vint1. A voltage difference between the second electrode and the gate electrode of the driving transistor M0 is: Vint2+Vth+Vda−Vint1−Vint3.

In the luminescent stage T4, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The first capacitor C1 and the second capacitor C2 are connected in series to form a new capacitor, and the voltages at the gate electrode of the driving transistor M0 and the first node are in a floating state. Since the fifth transistor M5 is turned on, the high voltage signal from the first power terminal ELVDD is input to the first electrode of the driving transistor M0, and the driving transistor M0 generates a driving current. The driving current flows through the driving transistor M0 to charge the anode of the light-emitting device L, and gradually raises VM0s to Vss+Voled, where Voled is a voltage difference between the cathode and the anode when the light-emitting device L is emitting light. Due to the coupling effect of the first capacitor C1 and the second capacitor C2, a variation of VM0s may be coupled to the gate electrode of the driving transistor M0, and a variation of the voltage at the gate electrode of the driving transistor M0 is Vss+Voled−Vint3, so that M0g=Vint2+Vth+Vda−Vint1+Vss+Voled−Vint3. Thus, a voltage difference Vgs between the gate electrode and the source electrode of the driving transistor M0 is Vint2+Vth+Vda−Vint1−Vint3. Thus, the driving transistor M0 operates in a saturation region, and the driving current I generated by the driving transistor M0 may be expressed as: I=K×(Vgs−Vth)²=K×(Vint2+Vda−Vint1−Vint3)². Where K=1/2*μ*Cox*W/L, μ is a mobility of the driving transistor M0, Cox is a capacitance of a gate insulating layer, and W/L is a width-to-length ratio of a channel of the driving transistor M0.

As can be seen from the above description, the driving current I is not related to the threshold voltage Vth of the driving transistor M0, the second power voltage Vss from the second power terminal ELVSS, and the Voled of the light-emitting device L, and thus the pixel circuit can solve the problem of non-uniform compensation of the threshold voltage of the driving transistor M0, the problem of a voltage drop of the second power voltage from the second power terminal ELVSS, and the problem of non-uniform display caused by aging of the light-emitting device L, thereby improving the display effect.

The process for compensating the threshold voltage is realized in the threshold compensation stage T2. The writing process of the data voltage is realized in the data writing stage T3, and the data voltage is coupled to the gate electrode of the driving transistor M0 based on the coupling effect of the first capacitor C1. In the luminescent stage T4, the first capacitor C1 and the second capacitor C2 are connected in series to form the new capacitor, which is beneficial to bootstrapping of the capacitor.

The path for compensating the threshold voltage of the driving transistor M0 is different from the path for writing the data voltage, and the compensation of the threshold voltage of the driving transistor M0 and the writing of the data voltage are also performed in different time, so that the compensation of the threshold voltage of the driving transistor M0 and the writing of the data voltage can be separately performed, and the high-frequency driving can be realized and the influence of the drifting of the threshold voltage of the driving transistor M0 on the light-emitting of the light-emitting device L can be avoided.

The process for compensating the threshold voltage of the driving transistor M0 and the process for writing the data voltage are separated from each other, the process for compensating the threshold voltage may be performed for a longer time, so as to ensure that the threshold voltage of the driving transistor M0 is compensated better, so that a driving frequency (such as 120 Hz, 180 Hz or 240 Hz) can be improved, the effect of the field scenes such as games and the like can be advantageously improved, the precision of the driving current can be improved, the display quality is improved, the light-emitting stability is further improved, and the display effect of the display panel is improved.

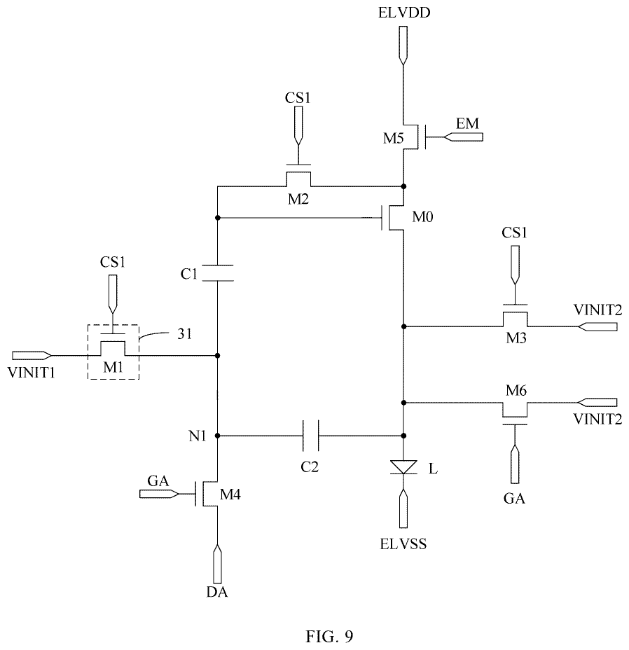

The embodiments of the present disclosure provide some other structures of the pixel circuit, as shown in FIG. 9, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 9, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 9, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal. For example, as shown in FIG. 9, the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 9 may be as shown in FIG. 5. In addition, the specific operating process of the pixel circuit shown in FIG. 9 in combination with the timing diagram of signals shown in FIG. 5 may refer to the description of the above embodiments, and is not repeated herein.

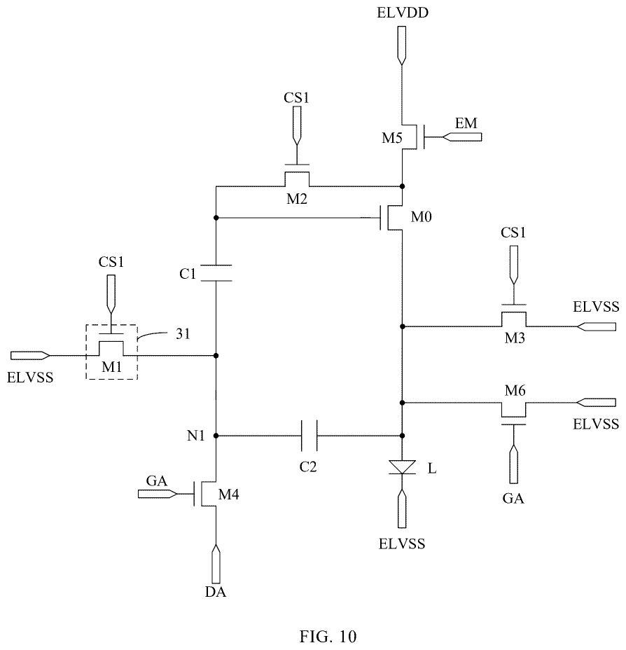

In the embodiments of the present disclosure, FIG. 10 is a schematic diagram of other structure of the pixel circuit, as shown in FIG. 10, which is modification for the implementation of the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 10, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 10, the gate electrode of the sixth transistor M6 is coupled to the scan signal terminal GA. Therefore, the number of signal lines can be reduced, and the wiring difficulty is reduced.

In the embodiment of the present disclosure, the first initialization signal terminal VINIT1, the second initialization signal terminal VINIT2 and the third initialization signal terminal VINIT3 may be the same signal terminal as the second power terminal ELVSS. For example, as shown in FIG. 10, the second electrode of the first transistor M1 is coupled to the second power terminal ELVSS, the first electrode of the sixth transistor M6 is coupled to the second power terminal ELVSS, and the first electrode of the third transistor M3 is coupled to the second power terminal ELVSS. Therefore, the number of signal lines can be reduced, and the wiring difficulty is reduced.

The timing diagram of the signals corresponding to the pixel circuit shown in FIG. 10 may be as shown in FIG. 5. In addition, the specific operating process of the pixel circuit shown in FIG. 10 in combination with the timing diagram of signals shown in FIG. 5 may refer to the description of the above embodiment, and is not repeated herein.

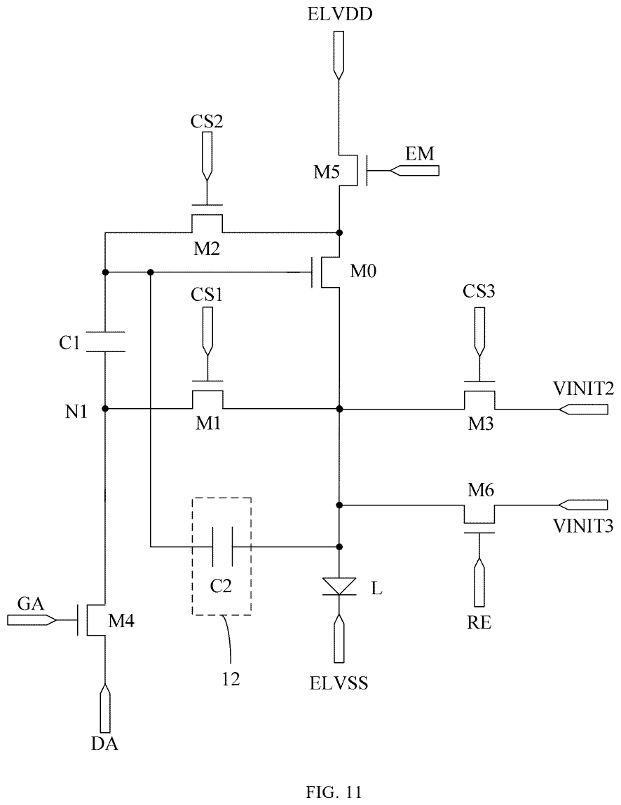

In the embodiments of the present disclosure, FIG. 11 is a schematic diagram of other structure of the pixel circuit, as shown in FIG. 11, which is modification for the implementation of the foregoing embodiments. Only the differences between the present embodiment and the above embodiments will be described below, and the parts that are substantially the same will not be described herein again.

In the embodiment of the present disclosure, as shown in FIG. 11, the second coupling control sub-circuit 12 may also be configured to stabilize the voltage at the second electrode of the driving transistor M0, and stabilize the voltage at the gate electrode of the driving transistor M0.

In the embodiment of the present disclosure, as shown in FIG. 11, the second plate of the first capacitor C1 is coupled to the gate electrode of the driving transistor M0.

The timing diagram of the signals corresponding to the pixel circuit shown in FIG. 11 may be as shown in FIG. 5.

In the initialization stage T1, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The turned-on fifth transistor M5 inputs a voltage from the first power terminal ELVDD to the first electrode of the driving transistor M0 to initialize the first electrode of the driving transistor M0. The turned-on second transistor M2 electrically connects the gate electrode with the first electrode of the driving transistor M0, so that a voltage VM0g at the gate electrode of the driving transistor M0 is the voltage Vdd from the first power terminal ELVDD, i.e., VM0g=Vdd, thereby initializing the gate electrode of the driving transistor M0. The turned-on third transistor M3 provides the second initialization signal from the second initialization signal terminal VINIT2 to the second electrode of the driving transistor M0, so that a voltage VM0s at the second electrode of the driving transistor M0 is a voltage Vint2 of the second initialization signal, that is, VM0s=Vint2, thereby initializing the second electrode of the driving transistor M0 and the anode of the light-emitting device L. The turned-on first transistor M1 electrically connects the second electrode of the driving transistor M0 with the first node N1, so that VN0=Vint2, thereby initializing the first node N1.

In the threshold compensation stage T2, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned off under the control of the low level of the light-emitting control signal, and the sixth transistor M6 is turned off under the control of the low level of the reset signal. The turned-on third transistor M3 provides the second initialization signal from the second initialization signal terminal VINIT2 to the second electrode of the driving transistor M0, so that the voltage VM0s at the second electrode of the driving transistor M0 is the voltage Vint2 of the second initialization signal, i.e., VM0s=Vint2. The turned-on first transistor M1 electrically connects the second electrode of the driving transistor M0 with the first node N1, so that VN0=Vint1. The turned-on second transistor M2 electrically connects the gate electrode with the first electrode of the driving transistor M0, so that the driving transistor M0 is in a diode connection mode. The voltage at the gate electrode of the driving transistor M0 is discharged through a path formed by the second transistor M2, the driving transistor M0 and the third transistor M3 to the second initialization signal terminal VINIT2, and decreases continuously from Vdd until VM0g=Vint2+Vth, thereby completing the compensation of the threshold voltage. Then, the driving transistor M0 is turned off.

In the data writing stage T3, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned on under the control of the high level of the scan signal, the fifth transistor M5 is turned off under the control of the low level of the light-emitting control signal, and the sixth transistor M6 is turned on under the control of the high level of the reset signal. The turned-on sixth transistor M6 provides the third initialization signal from the third initialization signal terminal VINIT3 to the second electrode of the driving transistor M0, so that the voltage VM0s at the second electrode of the driving transistor M0 is a voltage Vint3 of the third initialization signal, i.e., VM0s=Vint3. The turned-on fourth transistor M4 inputs the data voltage Vda from the data signal terminal DA to the first node N1, so that VN0=Vda. Since the gate electrode of the driving transistor M0 is in a floating state, a variation of the voltage at the gate electrode of the driving transistor M0 is equal to a variation of that the voltage at the first node N1, so that VM0g=Vint2+Vth+(Vda−Vint2)×c1/(c1+c2). A voltage difference between the second electrode and the gate electrode of the driving transistor M0 is: Vint2+Vth+(Vda−Vint2)×c1/(c1+c2)−Vint3, where c1 represents a capacitance of the first capacitor C1, and c2 represents a capacitance of the second capacitor C2.

In the luminescent stage T4, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The first capacitor C1 and the second capacitor C2 are connected in series to form a new capacitor, and the voltages at the gate electrode of the driving transistor M0 and the first node are in a floating state. Since the fifth transistor M5 is turned on, the high voltage signal from the first power terminal ELVDD is input to the first electrode of the driving transistor M0, and the driving transistor M0 generates a driving current. The driving current flows through the driving transistor M0 to charge the anode of the light-emitting device L, and gradually raises VM0s to Vss+Voled, where Voled is a voltage difference between the cathode and the anode when the light-emitting device L is emitting light. Due to the coupling effect of the first capacitor C1 and the second capacitor C2, a variation of VM0s may be coupled to the gate electrode of the driving transistor M0, and a variation of the voltage at the gate electrode of the driving transistor M0 is Vss+Voled−Vint3, so that VM0g=Vint2+Vth+(Vda−Vint2)×c1/(c1+c2)+Vss+Voled−Vint3. Thus, a voltage difference Vgs between the gate electrode and the source electrode of the driving transistor M0 is Vint2+Vth+(Vda−Vint2)×c1/(c1+c2)−Vint3. Thus, the driving transistor M0 operates in a saturation region, and the driving current I generated by the driving transistor M0 may be expressed as: I-K×(Vgs−Vth)²=K×(Vint2+(Vda−Vint2)×c1/(c1+c2)−Vint3)². Where K=1/2*μ*Cox*W/L, μ is a mobility of the driving transistor M0, Cox is a capacitance of a gate insulating layer, and W/L is a width-to-length ratio of a channel of the driving transistor M0.

As can be seen from the above description, the driving current I is not related to the threshold voltage Vth of the driving transistor M0, the second power voltage Vss from the second power terminal ELVSS, and the Voled of the light-emitting device L, and thus the pixel circuit can solve the problem of non-uniform compensation of the threshold voltage of the driving transistor M0, the problem of a voltage drop of the second power voltage from the second power terminal ELVSS, and the problem of non-uniform display caused by aging of the light-emitting device L, thereby improving the display effect.

The process for compensating the threshold voltage is realized in the threshold compensation stage T2. The writing process of the data voltage is realized in the data writing stage T3, and the data voltage is coupled to the gate electrode of the driving transistor M0 based on the coupling effect of the first capacitor C1. In the luminescent stage T4, the first capacitor C1 and the second capacitor C2 are connected in series to form the new capacitor, which is beneficial to bootstrapping of the capacitor.

The path for compensating the threshold voltage of the driving transistor M0 is different from the path for writing the data voltage, and the compensation of the threshold voltage of the driving transistor M0 and the writing of the data voltage are also performed in different time, so that the compensation of the threshold voltage of the driving transistor M0 and the writing of the data voltage can be separately performed, and the high-frequency driving can be realized and the influence of the drifting of the threshold voltage of the driving transistor M0 on the light-emitting of the light-emitting device L can be avoided.

The process for compensating the threshold voltage of the driving transistor M0 and the process for writing the data voltage are separated from each other, the process for compensating the threshold voltage may be performed for a longer time, so as to ensure that the threshold voltage of the driving transistor M0 is compensated better, so that a driving frequency (such as 120 Hz, 180 Hz or 240 Hz) can be improved, the effect of the field scenes such as games and the like can be advantageously improved, the precision of the driving current can be improved, the display quality is improved, the light-emitting stability is further improved, and the display effect of the display panel is improved.

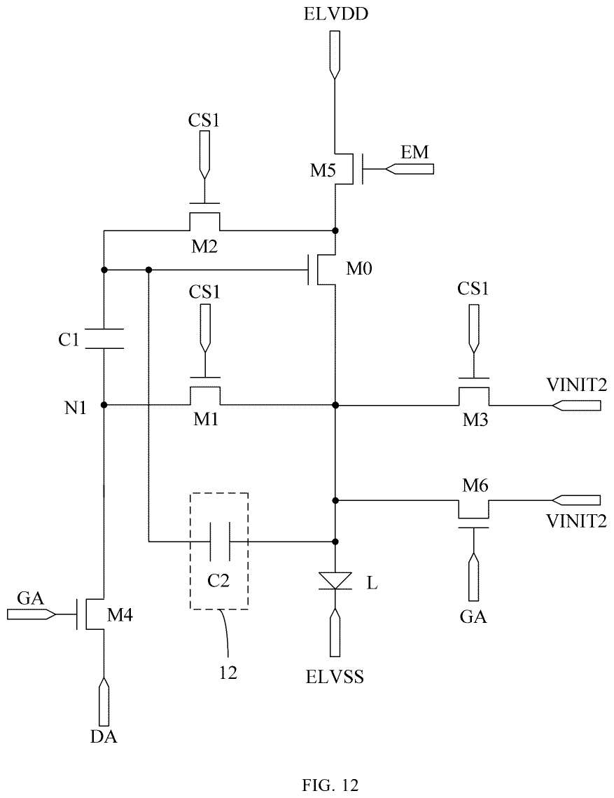

The embodiments of the present disclosure provide some other structures of the pixel circuit, as shown in FIG. 12, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 12, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 12, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal. For example, as shown in FIG. 12, the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 12 may be as shown in FIG. 5. In addition, the specific operating process of the pixel circuit shown in FIG. 12 in combination with the timing diagram of signals shown in FIG. 5 may refer to the description of the above embodiments, and is not repeated herein.

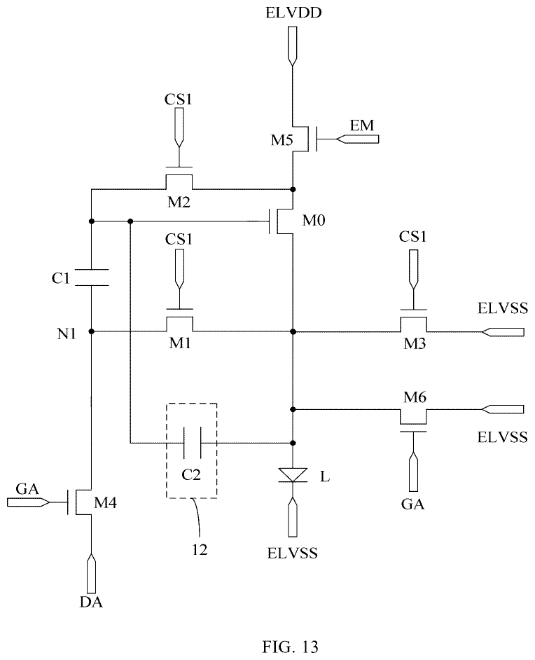

In the embodiments of the present disclosure, FIG. 13 is a schematic diagram of other structure of the pixel circuit, as shown in FIG. 13, which is modification for the implementation of the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 13, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 13, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal as the second power terminal ELVSS. For example, as shown in FIG. 13, the first electrode of the sixth transistor M6 is coupled to the second power terminal ELVSS, and the first electrode of the third transistor M3 is coupled to the second power terminal ELVSS. Therefore, the number of signal lines can be reduced, and the wiring difficulty is reduced.

The timing diagram of the signals corresponding to the pixel circuit shown in FIG. 13 may be as shown in FIG. 5. In addition, the specific operating process of the pixel circuit shown in FIG. 13 in combination with the timing diagram of signals shown in FIG. 5 may refer to the description of the above embodiment, and is not repeated herein.

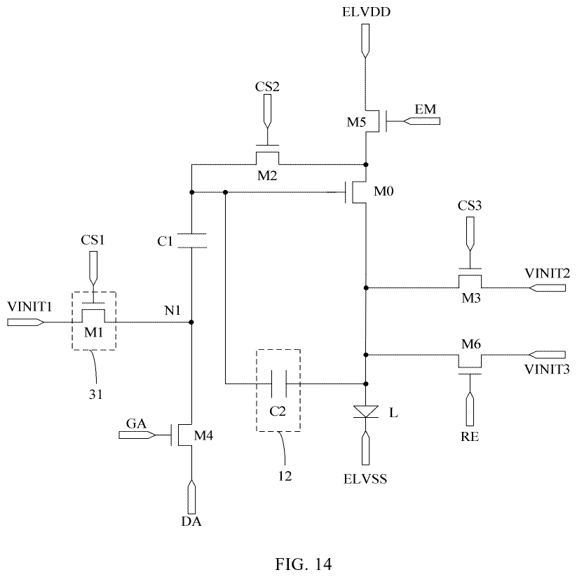

In the embodiments of the present disclosure, FIG. 14 is a schematic diagram of other structure of the pixel circuit, as shown in FIG. 14, which is modification for the implementation of the foregoing embodiments. Only the differences between the present embodiment and the above embodiments will be described below, and the parts that are substantially the same will not be described herein again.

In the embodiment of the present disclosure, as shown in FIG. 14, the first threshold compensation sub-circuit 31 may be configured to provide the signal from the first initialization signal terminal VINIT1 to the first node N1 in response to the signal from the first compensation control signal terminal CS1.

In the embodiment of the present disclosure, as shown in FIG. 14, the second electrode of the first transistor M1 is coupled to the first initialization signal terminal VINIT1.

In the embodiment of the present disclosure, as shown in FIG. 14, the second coupling control sub-circuit 12 may also be configured to stabilize the voltage at the second electrode of the driving transistor M0, and stabilize the voltage at the gate electrode of the driving transistor M0.

In the embodiment of the present disclosure, as shown in FIG. 14, the second plate of the first capacitor C1 is coupled to the gate electrode of the driving transistor M0.

The timing diagram of the signals corresponding to the pixel circuit shown in FIG. 14 may be as shown in FIG. 5.

In the initialization stage T1, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The turned-on fifth transistor M5 inputs a voltage from the first power terminal ELVDD to the first electrode of the driving transistor M0 to initialize the first electrode of the driving transistor M0. The turned-on second transistor M2 electrically connects the gate electrode with the first electrode of the driving transistor M0, so that a voltage VM0g at the gate electrode of the driving transistor M0 is the voltage Vdd from the first power terminal ELVDD, i.e., VM0g=Vdd, thereby initializing the gate electrode of the driving transistor M0. The turned-on third transistor M3 provides the second initialization signal from the second initialization signal terminal VINIT2 to the second electrode of the driving transistor M0, so that a voltage VM0s at the second electrode of the driving transistor M0 is a voltage Vint2 of the second initialization signal, that is, VM0s=Vint2, thereby initializing the second electrode of the driving transistor M0 and the anode of the light-emitting device L. The turned-on first transistor M1 provides the first initialization signal from the first initialization signal terminal VINIT1 to the first node N1 so that the voltage VN0 at the first node N1 is the voltage Vint1 of the first initialization signal, that is, VN0=Vint1, and initializes the first node N1.

In the threshold compensation stage T2, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned off under the control of the low level of the light-emitting control signal, and the sixth transistor M6 is turned off under the control of the low level of the reset signal. The turned-on third transistor M3 provides the second initialization signal from the second initialization signal terminal VINIT2 to the second electrode of the driving transistor M0, so that the voltage VM0s at the second electrode of the driving transistor M0 is the voltage Vint2 of the second initialization signal, i.e., VM0s=Vint2. The turned-on first transistor M1 provides the first initialization signal from the first initialization signal terminal VINIT1 to the first node N1, so that VN0=Vint1. The turned-on second transistor M2 electrically connects the gate electrode with the first electrode of the driving transistor M0, so that the driving transistor M0 is in a diode connection mode. The voltage at the gate electrode of the driving transistor M0 is discharged through a path formed by the second transistor M2, the driving transistor M0 and the third transistor M3 to the second initialization signal terminal VINIT2, and decreases continuously from Vdd until VM0g=Vint2+Vth, thereby completing the compensation of the threshold voltage. Then, the driving transistor M0 is turned off.

In the data writing stage T3, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned on under the control of the high level of the scan signal, the fifth transistor M5 is turned off under the control of the low level of the light-emitting control signal, and the sixth transistor M6 is turned on under the control of the high level of the reset signal. The turned-on sixth transistor M6 provides the third initialization signal from the third initialization signal terminal VINIT3 to the second electrode of the driving transistor M0, so that the voltage VM0s at the second electrode of the driving transistor M0 is a voltage Vint3 of the third initialization signal, i.e., VM0s=Vint3. The turned-on fourth transistor M4 inputs the data voltage Vda from the data signal terminal DA to the first node N1, so that VN0=Vda. Since the gate electrode of the driving transistor M0 is in a floating state, a variation of the voltage at the gate electrode of the driving transistor M0 is equal to a variation of the at voltage first the node N1, so that VM0g=Vint2+Vth+(Vda−Vint1)×c1/(c1+c2). A voltage difference between the second electrode and the gate electrode of the driving transistor M0 is: Vint2+Vth+(Vda−Vint1)×c1/(c1+c2)−Vint3, where c1 represents a capacitance of the first capacitor C1, and c2 represents a capacitance of the second capacitor C2.

In the luminescent stage T4, the first transistor M1 is turned off under the control of the low level of the first compensation control signal, the second transistor M2 is turned off under the control of the low level of the second compensation control signal, the third transistor M3 is turned off under the control of the low level of the third compensation control signal, the fourth transistor M4 is turned off under the control of the low level of the scan signal, the fifth transistor M5 is turned on under the control of the high level of the light-emitting control signal, and the sixth transistor M6 is turned off under the control of the low level of the reset signal. The first capacitor C1 and the second capacitor C2 are connected in series to form a new capacitor, and the voltages at the gate electrode of the driving transistor M0 and the first node are in a floating state. Since the fifth transistor M5 is turned on, the high voltage signal from the first power terminal ELVDD is input to the first electrode of the driving transistor M0, and the driving transistor M0 generates a driving current. The driving current flows through the driving transistor M0 to charge the anode of the light-emitting device L, and gradually raises VM0s to Vss+Voled, where Voled is a voltage difference between the cathode and the anode when the light-emitting device L is emitting light. Due to the coupling effect of the first capacitor C1 and the second capacitor C2, a variation of VM0s may be coupled to the gate electrode of the driving transistor M0, and a variation of the voltage at the gate electrode of the driving transistor M0 is Vss+Voled−Vint3, so that VM0g=Vint2+Vth+(Vda−Vint1)×c1/(c1+c2)+Vss+Voled−Vint3. Thus, a voltage difference Vgs between the gate electrode and the source electrode of the driving transistor M0 is Vint2+Vth+(Vda−Vint1)×c1/(c1+c2)−Vint3. Thus, the driving transistor M0 operates in a saturation region, and the driving current I generated by the driving transistor M0 may be expressed as: I=K×(Vgs−Vth)²=K×(Vint2+(Vda−Vint1)×c1/(c1+c2)−Vint3)². Where K=1/2*μ*Cox*W/L, μ is a mobility of the driving transistor M0, Cox is a capacitance of a gate insulating layer, and W/L is a width-to-length ratio of a channel of the driving transistor M0.

As can be seen from the above description, the driving current I is not related to the threshold voltage Vth of the driving transistor M0, the second power voltage Vss from the second power terminal ELVSS, and the Voled of the light-emitting device L, and thus the pixel circuit can solve the problem of non-uniform compensation of the threshold voltage of the driving transistor M0, the problem of a voltage drop of the second power voltage from the second power terminal ELVSS, and the problem of non-uniform display caused by aging of the light-emitting device L, thereby improving the display effect.

The process for compensating the threshold voltage is realized in the threshold compensation stage T2. The writing process of the data voltage is realized in the data writing stage T3, and the data voltage is coupled to the gate electrode of the driving transistor M0 based on the coupling effect of the first capacitor C1. In the luminescent stage T4, the first capacitor C1 and the second capacitor C2 are connected in series to form the new capacitor, which is beneficial to bootstrapping of the capacitor.

The path for compensating the threshold voltage of the driving transistor M0 is different from the path for writing the data voltage, and the compensation of the threshold voltage of the driving transistor M0 and the writing of the data voltage are also performed in different time, so that the compensation of the threshold voltage of the driving transistor M0 and the writing of the data voltage can be separately performed, and the high-frequency driving can be realized and the influence of the drifting of the threshold voltage of the driving transistor M0 on the light-emitting of the light-emitting device L can be avoided.

The process for compensating the threshold voltage of the driving transistor M0 and the process for writing the data voltage are separated from each other, the process for compensating the threshold voltage may be performed for a longer time, so as to ensure that the threshold voltage of the driving transistor M0 is compensated better, so that a driving frequency (such as 120 Hz, 180 Hz or 240 Hz) can be improved, the effect of the field scenes such as games and the like can be advantageously improved, the precision of the driving current can be improved, the display quality is improved, the light-emitting stability is further improved, and the display effect of the display panel is improved.

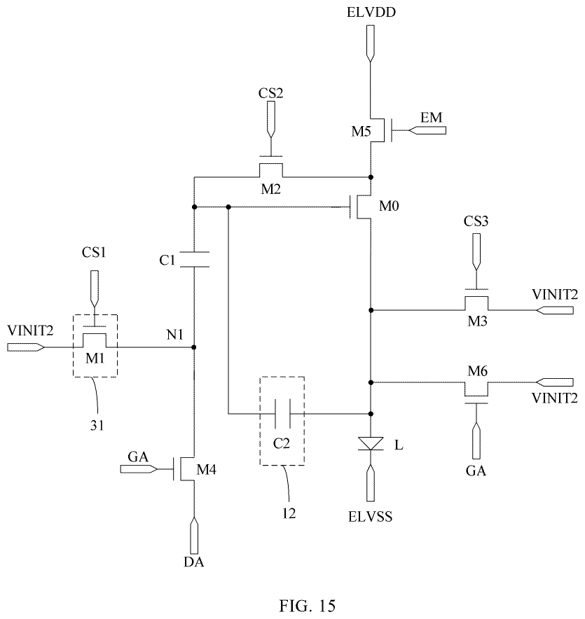

The embodiments of the present disclosure provide some other structures of the pixel circuit, as shown in FIG. 15, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 15, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 15, the gate electrode of the sixth transistor M6 is coupled to the scan signal terminal GA. Therefore, the number of signal lines can be reduced, and the wiring difficulty is reduced.

In the embodiments of the present disclosure, the first initialization signal terminal VINIT1, the second initialization signal terminal VINIT2 and the third initialization signal terminal VINIT3 may be the same signal terminal. For example, as shown in FIG. 15, the second electrode of the first transistor M1 is coupled to the second initialization signal terminal VINIT2, and the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 15 may be as shown in FIG. 5. In addition, the specific operating process of the pixel circuit shown in FIG. 15 in combination with the timing diagram of signals shown in FIG. 5 may refer to the description of the above embodiments, and is not repeated herein.

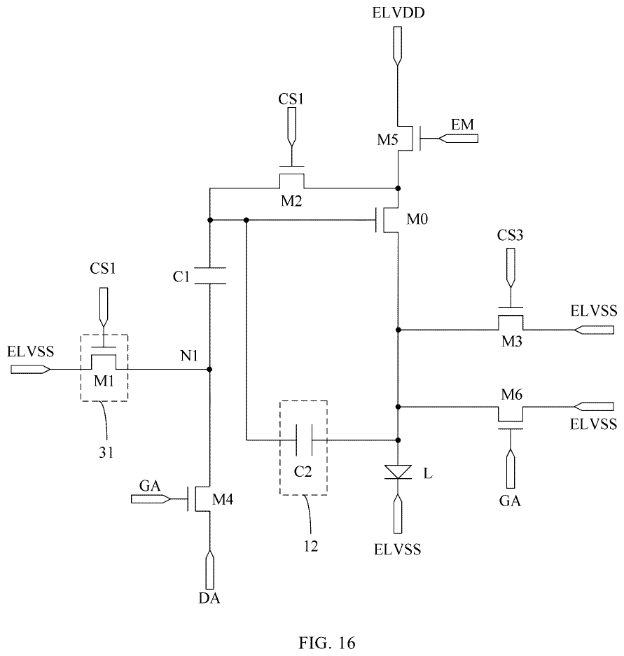

In the embodiments of the present disclosure, FIG. 16 is a schematic diagram of other structure of the pixel circuit, as shown in FIG. 16, which is modification for the implementation of the foregoing embodiments. Only the differences between the present embodiment and the above embodiments will be described below, and the parts that are substantially the same will not be described herein again.

In the embodiment of the present disclosure, the first compensation control signal terminal, the second compensation control signal terminal, and the third compensation control signal terminal may be the same signal terminal. For example, as shown in FIG. 16, the gate electrode of the second transistor M2 is coupled to the first compensation control signal terminal CS1, and the gate electrode of the third transistor M3 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 16, the gate electrode of the sixth transistor M6 is coupled to the scan signal terminal GA. Therefore, the number of signal lines can be reduced, and the wiring difficulty is reduced.

In the embodiment of the present disclosure, the first initialization signal terminal VINIT1, the second initialization signal terminal VINIT2 and the third initialization signal terminal VINIT3 may be the same signal terminal as the second power terminal ELVSS. For example, as shown in FIG. 16, the first electrode of the sixth transistor M6 is coupled to the second power terminal ELVSS, the first electrode of the third transistor M3 is coupled to the second power terminal ELVSS and the second electrode of the first transistor M1 is coupled to the second power terminal ELVSS. Therefore, the number of signal lines can be reduced, and the wiring difficulty is reduced.

The timing diagram of the signals corresponding to the pixel circuit shown in FIG. 16 may be as shown in FIG. 5. In addition, the specific operating process of the pixel circuit shown in FIG. 16 in combination with the timing diagram of signals shown in FIG. 5 may refer to the description of the above embodiment, and is not repeated herein.

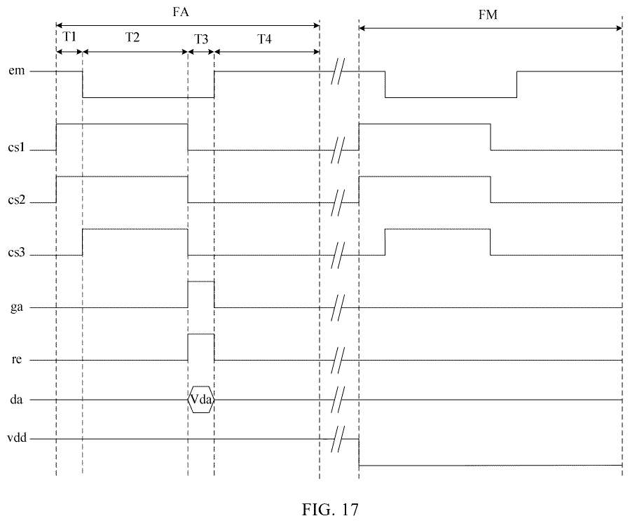

In the embodiments of the present disclosure, FIG. 17 is a schematic diagram of other timing diagram of the pixel circuit, as shown in FIG. 17, which is modification for the implementation of the foregoing embodiments. Only the differences between the present embodiment and the above embodiments will be described below, and the parts that are substantially the same will not be described herein again.

In the embodiment of the present disclosure, as shown in FIG. 17, the first compensation control signal cs1 may be the same as the second compensation control signal cs2, and the first compensation control signal cs1 may be different from the third compensation control signal cs3.

An operating process of the pixel circuit provided in the embodiment of the present disclosure will be described by taking the pixel driving circuit shown in FIG. 3 as an example and combining a timing diagram of signals shown in FIG. 17.

In the embodiment of the present disclosure, as shown in FIG. 17, em represents the light-emitting control signal from the light-emitting control signal terminal EM, cs represents the compensation control signal from the compensation control signal terminal, re represents the reset signal from the reset signal terminal RE, ga represents the scan signal from the scan signal terminal GA, da represents the data voltage signal from the data signal terminal DA, and vdd represents a signal from the first power terminal ELVDD.

The initialization stage T1, the threshold compensation stage T2, the data writing stage T3, and the luminescent stage T4 in any one display frame FA are selected. In the initialization stage T1, the third transistor M3 is turned off under the control of the low level of the third compensation control signal. In addition, the rest of the operating processes of the pixel circuit may refer to the above description, and is not described herein again.

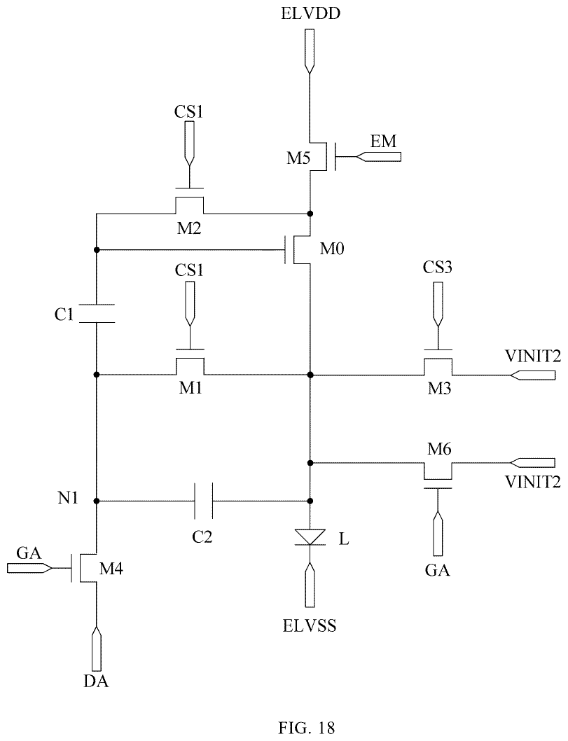

The embodiments of the present disclosure provide some other structures of the pixel circuit, as shown in FIG. 18, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal and the second compensation control signal terminal may be the same signal terminal. The first compensation control signal terminal and the third compensation control signal terminal may be different signal terminals. For example, as shown in FIG. 18, the gate electrode of the second transistor M2 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 18, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal. For example, as shown in FIG. 18, the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 18 may be as shown in FIG. 17. In addition, the specific operating process of the pixel circuit shown in FIG. 18 in combination with the timing diagram of signals shown in FIG. 17 may refer to the description of the above embodiments, and is not repeated herein.

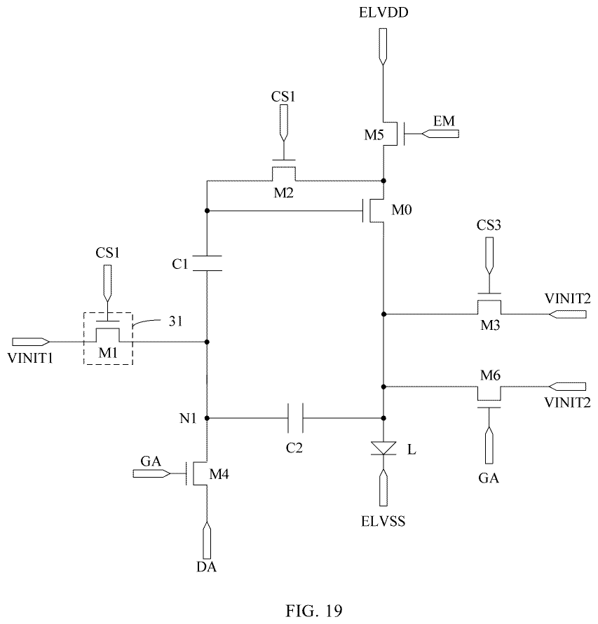

The embodiments of the present disclosure provide some other structures of the pixel circuit, as shown in FIG. 19, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal and the second compensation control signal terminal may be the same signal terminal. The first compensation control signal terminal and the third compensation control signal terminal may be different signal terminals. For example, as shown in FIG. 19, the gate electrode of the second transistor M2 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 19, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal. For example, as shown in FIG. 19, the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 19 may be as shown in FIG. 17. In addition, the specific operating process of the pixel circuit shown in FIG. 19 in combination with the timing diagram of signals shown in FIG. 17 may refer to the description of the above embodiments, and is not repeated herein.

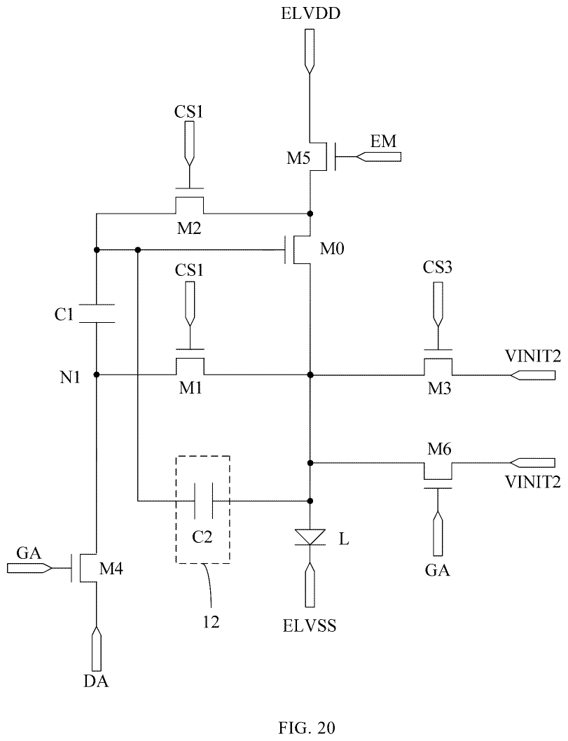

The embodiments of the present disclosure provide some other structures of the pixel circuit, as shown in FIG. 20, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal and the second compensation control signal terminal may be the same signal terminal. The first compensation control signal terminal and the third compensation control signal terminal may be different signal terminals. For example, as shown in FIG. 20, the gate electrode of the second transistor M2 is coupled to the first compensation control signal terminal CS1. Therefore, the number of signal lines can be reduced, and the wiring difficulty is reduced.

In the embodiment of the present disclosure, the reset signal terminal RE and the scan signal terminal GA may be the same signal terminal. For example, as shown in FIG. 20, the gate electrode of the sixth transistor M6 is coupled to the scan signal terminal GA. Therefore, the number of signal lines can be reduced, and the wiring difficulty is reduced.

In the embodiment of the present disclosure, the second initialization signal terminal VINIT2 and the third initialization signal terminal VINIT3 may be the same signal terminal. For example, as shown in FIG. 20, the first electrode of the sixth transistor M6 is coupled to the second initialization signal terminal VINIT2. Therefore, the number of signal lines can be reduced, and the wiring difficulty is reduced.

The timing diagram of the signals corresponding to the pixel circuit shown in FIG. 20 may be as shown in FIG. 17. In addition, the specific operating process of the pixel circuit shown in FIG. 20 in combination with the timing diagram of signals shown in FIG. 17 may refer to the description of the above embodiments, and is not repeated herein.

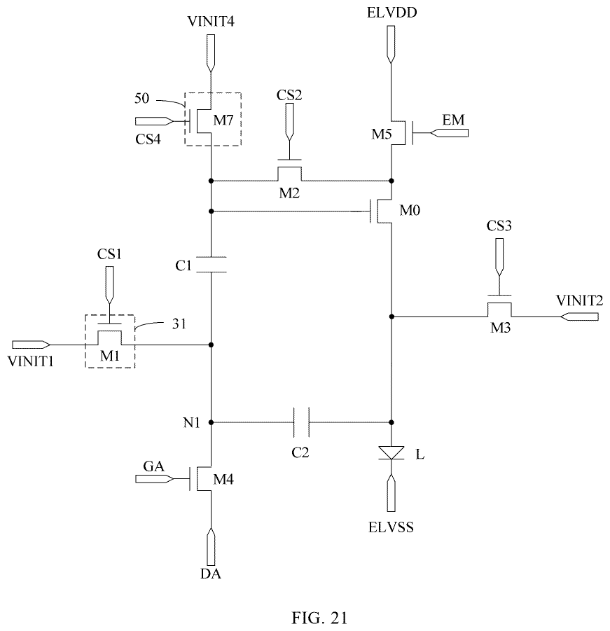

The embodiments of the present disclosure provide some other structures of the pixel circuit, as shown in FIG. 21, which are modified from the embodiments in the foregoing embodiments. Only the differences between the present embodiment and the above embodiments will be described below, and the parts that are substantially the same will not be described herein again.

In the embodiment of the present disclosure, as shown in FIG. 21, the first threshold compensation sub-circuit 31 may be configured to provide the signal from the first initialization signal terminal VINIT1 to the first node N1 in response to the signal from the first compensation control signal terminal CS1.

In the embodiment of the present disclosure, as shown in FIG. 21, the second electrode of the first transistor M1 is coupled to the first initialization signal terminal VINIT1.

In the embodiment of the present disclosure, as shown in FIG. 21, the pixel circuit further includes: an initialization circuit 50 configured to provide a signal from a fourth initialization signal terminal VINIT4 to the gate electrode of the driving transistor M0 in response to a signal from the fourth compensation control signal terminal CS4.

In the embodiment of the present disclosure, as shown in FIG. 21, the initialization circuit includes: a seventh transistor M7, a gate electrode of the seventh transistor M7 is coupled to the fourth compensation control signal terminal CS4, a first electrode of the seventh transistor M7 is coupled to the fourth initialization signal terminal CS4, and a second electrode of the seventh transistor M7 is coupled to the gate electrode of the driving transistor M0.

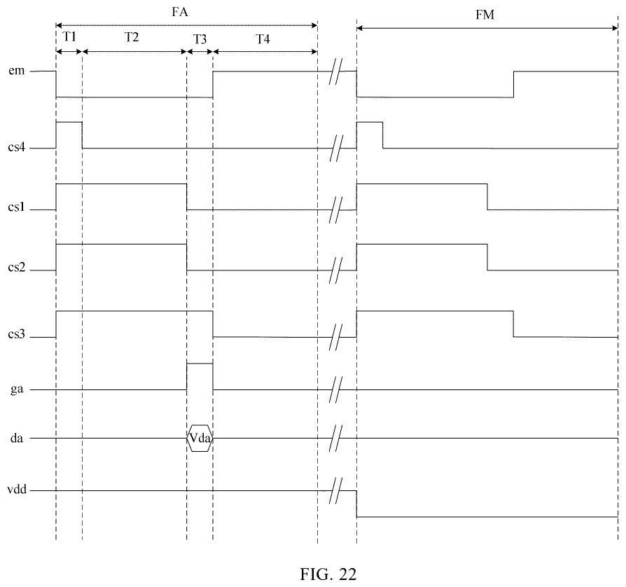

The timing diagram of the signals corresponding to the pixel circuit shown in FIG. 21 may be as shown in FIG. 22. In the embodiment of the present disclosure, as shown in FIG. 22, em represents the light-emitting control signal from the light-emitting control signal terminal EM, cs1 represents the first compensation control signal from the first compensation control signal terminal CS1, cs2 represents the second compensation control signal from the second compensation control signal terminal CS2, cs3 represents the third compensation control signal from the third compensation control signal terminal CS3, cs4 represents the fourth compensation control signal from the fourth compensation control signal terminal CS4, re represents the reset signal from the reset signal terminal RE, ga represents the scan signal from the scan signal terminal GA, da represents the data voltage signal from the data signal terminal DA, and vdd represents a signal from the first power terminal ELVDD.

The initialization stage T1, the threshold compensation stage T2, the data writing stage T3, and the luminescent stage T4 in any one display frame FA are selected.

In the initialization stage T1, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned off under the control of the low level of the light-emitting control signal, the sixth transistor M6 is turned off under the control of the low level of the reset signal and the seventh transistor M7 is turned on under the control of the high level of the fourth compensation control signal.

The turned-on seventh transistor M7 inputs a voltage from the fourth initialization signal terminal VINIT4 to the gate electrode of the driving transistor M0, so that the voltage VM0g at the gate electrode of the driving transistor M0 is a voltage Vinit4 at the fourth initialization signal terminal VINIT4, that is, VM0g=Vinit4, thereby initializing the gate electrode of the driving transistor M0. The turned-on second transistor M2 electrically connects the gate electrode to the first electrode of the driving transistor M0, so that the voltage at the first electrode of the driving transistor M0 is VM0g, thereby initializing the first electrode of the driving transistor M0. The turned-on third transistor M3 provides the second initialization signal from the second initialization signal terminal VINIT2 to the second electrode of the driving transistor M0, so that the voltage VM0s at the second electrode of the driving transistor M0 is the voltage Vint2 of the second initialization signal, that is, VM0s=Vint2, thereby initializing the second electrode of the driving transistor M0 and the anode of the light-emitting device L. The turned-on first transistor M1 provides the first initialization signal from the first initialization signal terminal VINIT1 to the first node N1, so that the voltage VN0 at the first node N1 is the voltage Vint1 of the first initialization signal, that is, VN0=Vint1, thereby initializing the first node N1.

In the threshold compensation stage T2, the data writing stage T3, and the luminescent stage T4, the seventh transistor M7 is turned off under the control of the low level of the fourth compensation control signal. The operating process of the remaining transistors may refer to the above description, and is not described herein again.

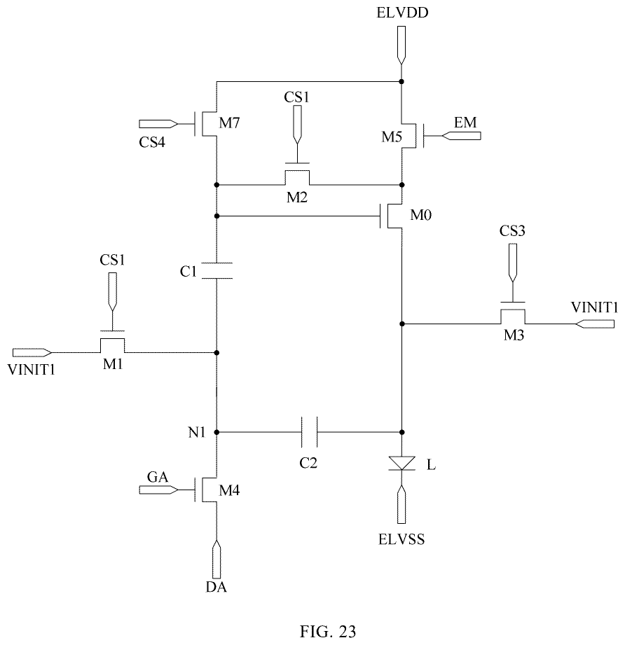

The embodiments of the present disclosure provide some other structures of the pixel circuit, as shown in FIG. 23, which are modified from the embodiments in the foregoing embodiments. Only the differences between the present embodiment and the above embodiments will be described below, and the parts that are substantially the same will not be described herein again.

In the embodiment of the present disclosure, the first compensation control signal terminal and the second compensation control signal terminal may be the same signal terminal. For example, as shown in FIG. 23, the gate electrode of the second transistor M2 is coupled to the first compensation control signal terminal CS1. Therefore, the number of signal lines can be reduced, and the wiring difficulty is reduced.

In the embodiment of the present disclosure, the second initialization signal terminal VINIT2 may be the same signal terminal as the first initialization signal terminal VINIT1. For example, as shown in FIG. 23, the first electrode of the third transistor M3 is coupled to the first initialization signal terminal VINIT1. Therefore, the number of signal lines can be reduced, and the wiring difficulty is reduced.

In the embodiment of the present disclosure, the fourth initialization signal terminal VINIT4 may be the same signal terminal as the first power terminal ELVDD. For example, as shown in FIG. 23, the first electrode of the seventh transistor M7 is coupled to the first power terminal ELVDD. Therefore, the number of signal lines can be reduced, and the wiring difficulty is reduced.

The timing diagram of the signals corresponding to the pixel circuit shown in FIG. 23 may be as shown in FIG. 22. In addition, the specific operating process of the pixel circuit shown in FIG. 23 in combination with the timing diagram of signals shown in FIG. 22 may refer to the description of the above embodiment, and is not repeated herein.

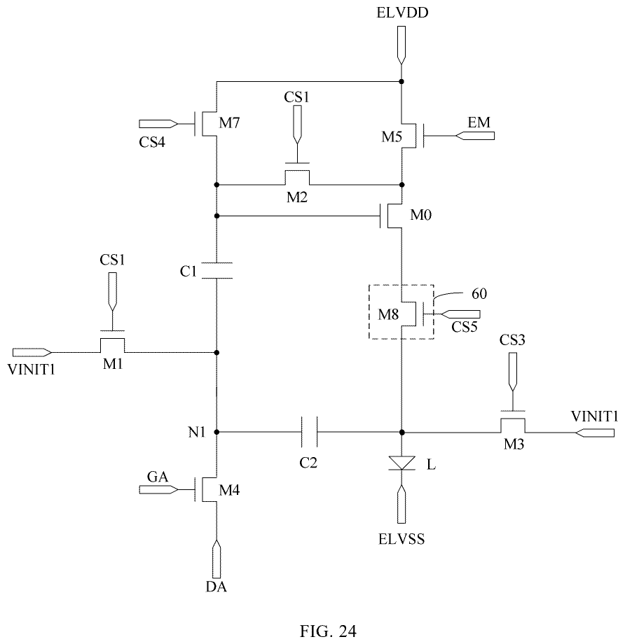

In the embodiments of the present disclosure, FIG. 24 is a schematic diagram of other structure of the pixel circuit, as shown in FIG. 24, which is modification for the implementation of the foregoing embodiments. Only the differences between the present embodiment and the above embodiments will be described below, and the parts that are substantially the same will not be described herein again.

In the embodiment of the present disclosure, as shown in FIG. 24, the pixel circuit further includes a light-emitting control circuit 60, wherein the second electrode of the driving transistor M0 is coupled to the anode of the light-emitting device L through the light-emitting control circuit 60. Also, the light-emitting control circuit 60 is configured to electrically connect the second electrode of the driving transistor M0 to the anode of the light-emitting device L in response to a signal from a fifth compensation control signal terminal CS5. In this way, the influence of the change of the voltage at the gate electrode of the driving transistor on the first code can be avoided.

Optionally, the signal from the fifth compensation control signal terminal CS5 may be a pulse width modulation (PWM) signal, so that the pixel circuit also has a PWM adjustment function when driven at a low refresh frequency.

In the present embodiment of the present disclosure, as shown in FIG. 24, the light-emitting control circuit 60 includes an eighth transistor M8. A gate electrode of the eighth transistor M8 is coupled to the fifth compensation control signal terminal CS5, a first electrode of the eighth transistor M8 is coupled to the second electrode of the driving transistor M0, and a second electrode of the eighth transistor M8 is coupled to the anode of the light-emitting device L.

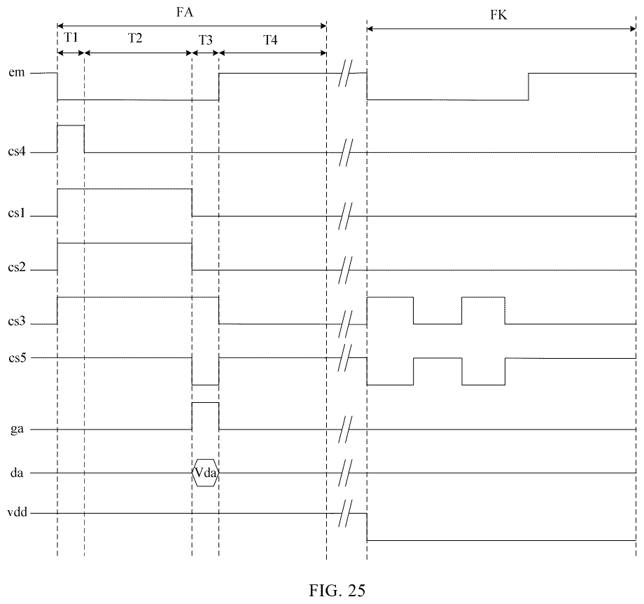

The timing diagram of the signals corresponding to the pixel circuit shown in FIG. 24 may be as shown in FIG. 25. In the embodiment of the present disclosure, as shown in FIG. 25, em represents the light-emitting control signal from the light-emitting control signal terminal EM, cs1 represents the first compensation control signal from the first compensation control signal terminal CS1, cs2 represents the second compensation control signal from the second compensation control signal terminal CS2, cs3 represents the third compensation control signal from the third compensation control signal terminal CS3, cs4 represents the fourth compensation control signal from the fourth compensation control signal terminal CS4, cs5 represents a fifth compensation control signal from the fifth compensation control signal terminal CS5, re represents the reset signal from the reset signal terminal RE, ga represents the scan signal from the scan signal terminal GA, da represents the data voltage signal from the data signal terminal DA, and vdd represents a signal from the first power terminal ELVDD.

The initialization stage T1, the threshold compensation stage T2, the data writing stage T3, and the luminescent stage T4 in any one display frame FA are selected.

In the initialization stage T1, the first transistor M1 is turned on under the control of the high level of the first compensation control signal, the second transistor M2 is turned on under the control of the high level of the second compensation control signal, the third transistor M3 is turned on under the control of the high level of the third compensation control signal, the fourth transistor M4 is turned off under the control of the low level of the scan signal, the fifth transistor M5 is turned off under the control of the low level of the light-emitting control signal, the sixth transistor M6 is turned off under the control of the low level of the reset signal, the seventh transistor M7 is turned on under the control of the high level of the fourth compensation control signal and the eighth transistor M8 is turned on under the control of the high level of the fifth compensation control signal.

The turned-on seventh transistor M7 inputs a voltage from the fourth initialization signal terminal VINIT4 to the gate electrode of the driving transistor M0, so that the voltage VM0g at the gate electrode of the driving transistor M0 is a voltage Vinit4 at the fourth initialization signal terminal VINIT4, that is, VM0g=Vinit4, thereby initializing the gate electrode of the driving transistor M0. The turned-on second transistor M2 electrically connects the gate electrode to the first electrode of the driving transistor M0, so that the voltage at the first electrode of the driving transistor M0 is VM0g, thereby initializing the first electrode of the driving transistor M0. The turned-on third transistor M3 provides the second initialization signal from the second initialization signal terminal VINIT2 to the anode of the light-emitting device L, thereby initializing the anode of the light-emitting device L. The turned-on eighth transistor M8 electrically connects the second electrode of the driving transistor M0 to the anode of the light-emitting device L, so that the voltage VM0s at the second electrode of the driving transistor M0 is the voltage Vint2 of the second initialization signal, that is, VM0s=Vint2, thereby initializing the second electrode of the driving transistor M0. The turned-on first transistor M1 provides the first initialization signal from the first initialization signal terminal VINIT1 to the first node N1, so that the voltage VN0 at the first node N1 is the voltage Vint1 of the first initialization signal, that is, VN0=Vint1, thereby initializing the first node N1.

In the threshold compensation stage T2, the eighth transistor M8 is turned on under the control of the high level of the fifth compensation control signal. In the data writing stage T3, the eighth transistor M8 is turned off under the control of the low level of the fifth compensation control signal. In the luminescent stage T4, the eighth transistor M8 is turned on under the control of the high level of the fifth compensation control signal. The operating process of the remaining transistors may refer to the above description, and is not described herein again.

The pixel circuit provided by the present disclosure may be capable of be driven at any one of a variety of different refresh frequencies, e.g., 1 Hz, 30 Hz, 60 Hz, 120 Hz and 240 Hz and the like. At the maximum refresh frequency (e.g., 240 Hz), FA in FIG. 25 may represent a driving timing of the pixel circuit in each display frame. At any one refresh frequency (e.g., 1 Hz, 30 Hz, 60 Hz, or 120 Hz) less than the maximum refresh frequency, each display frame includes a refresh sub-frame and a hold sub-frame, where FA in FIG. 25 may represent a driving timing of the pixel circuit in the refresh sub-frame, and FK in FIG. 25 may represent a driving timing of the pixel circuit in the hold sub-frame. In the driving at a low refresh frequency, such as 1 Hz, each second includes 1 refresh sub-frame and 59 hold sub-frames. In the hold sub-frames, an initialization frequency of the anode is dynamically changed by switching between the third transistor M3 and the eighth transistor M8, thereby reducing the impact of hysteresis and further improving the image quality.

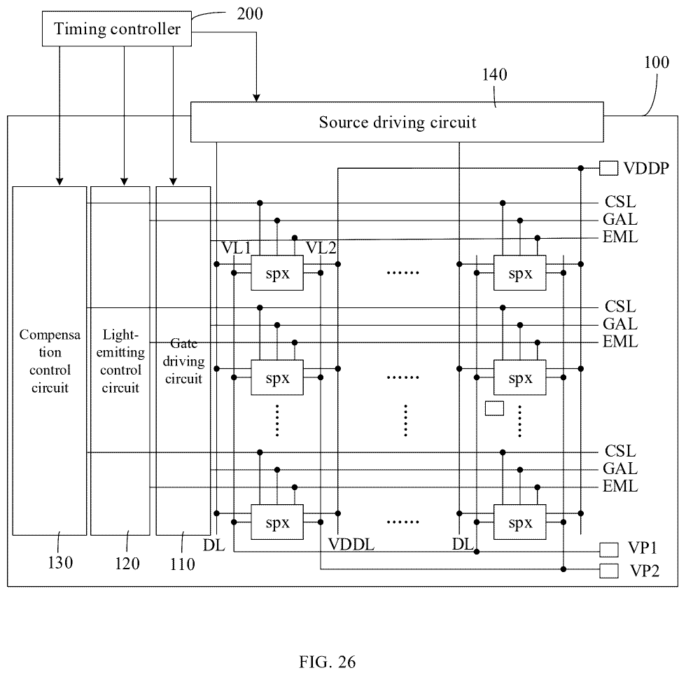

The embodiment of the present disclosure further provides a display panel, as shown in FIG. 26, the display panel 100 includes: a plurality of pixel units arranged in an array. Illustratively, each pixel unit includes a plurality of sub-pixels spx. Each sub-pixel spx includes any of the pixel circuits described above provided by embodiments of the present disclosure. The principle of the display panel to solve the problem is similar to that of the pixel circuit, so the implementation of the display panel may refer to the implementation of the pixel circuit, and the repeated parts are not described herein again.

In some embodiments of the present disclosure, as shown in FIG. 26, the display panel 100 further includes: a plurality of scan signal lines GAL, a plurality of light-emitting control signal lines EML, and a plurality of compensation control signal lines CSL. The plurality of scan signal lines GAL, the plurality of light-emitting control signal lines EML, and the plurality of compensation control signal lines CSL extend along a row direction of the sub-pixels. Optionally, each of the plurality of scan signal lines GAL is coupled to the scan signal terminals GA of the pixel circuits in a corresponding row of sub-pixels. Each of the plurality of light-emitting control signal lines EML is coupled to the light-emitting control signal terminals EM of the pixel circuits in a corresponding row of sub-pixels. Each of the plurality of compensation control signal lines CSL is coupled to the first compensation control signal terminals CS1 of the pixel circuits in a corresponding row of sub-pixels.

In some embodiments of the present disclosure, each pixel circuit includes the reset signal terminal RE, and the display panel further includes: a plurality of reset signal lines. The plurality of reset signal lines extend along the row direction of the sub-pixels. Optionally, each of the plurality of reset signal lines is coupled to the reset signal terminals RE of the pixel circuits in a corresponding row of sub-pixels.

Alternatively, in some embodiments of the present disclosure, each pixel circuit includes the reset signal terminal RE, and each of the plurality of scan signal lines GAL is coupled to the reset signal terminals RE of the pixel circuits in a corresponding row of sub-pixels.

In some embodiments of the present disclosure, each pixel circuit includes the second compensation signal terminal CS2, and the display panel further includes: a plurality of second compensation control signal lines. The plurality of second compensation control signal lines extend along the row direction of the sub-pixels. Optionally, each of the plurality of second compensation control signal lines is coupled to the second compensation control signal terminals CS2 of the pixel circuits in a corresponding row of sub-pixels.

Alternatively, in some embodiments of the present disclosure, each pixel circuit includes the second compensation signal terminal CS2, and each of the plurality of compensation control signal lines CSL is coupled to the second compensation control signal terminals CS2 of the pixel circuits in a corresponding row of sub-pixels.

In some embodiments of the present disclosure, each pixel circuit includes the third compensation signal terminal CS3, and the display panel further includes: a plurality of third compensation control signal lines. The plurality of third compensation control signal lines extend along the row direction of the sub-pixels. Optionally, each of the plurality of third compensation control signal lines is coupled to the third compensation control signal terminals CS3 of the pixel circuits in a corresponding row of sub-pixels.

Alternatively, in some embodiments of the present disclosure, each pixel circuit includes the third compensation signal terminal CS3, and each of the plurality of compensation control signal lines CSL is coupled to the third compensation control signal terminals CS3 of the pixel circuits in a corresponding row of sub-pixels.

In some embodiments of the present disclosure, as shown in FIG. 26, the display panel 100 further includes: a plurality of data lines DL, a plurality of second initialization signal lines VL2, and a plurality of first power lines VDDL. The plurality of data lines DL, the plurality of first initialization signal lines VL1, the plurality of second initialization signal lines VL2 and the plurality of first power lines VDDL extend along a column direction of the sub-pixels. Optionally, each of the plurality of data lines DL is coupled to the data signal terminals DA of the pixel circuits in a corresponding column of sub-pixels. Each of the plurality of second initialization signal lines VL2 is coupled to the second initialization signal terminals VINIT2 of the pixel circuits in a corresponding column of sub-pixels. Each of the plurality of first power lines VDDL is coupled to the first power terminals ELVDD for the pixel circuits in a corresponding column of sub-pixels.

Illustratively, as shown in FIG. 26, the display panel 100 further includes: a second initialization signal terminal VP2. The plurality of second initialization signal lines VL2 are connected to a second initialization signal bus coupled to the second initialization signal terminal VP2.

Illustratively, as shown in FIG. 26, the display panel 100 further includes: a first power terminal VDDP. The plurality of first power lines VDDL are connected to a first power bus coupled to the first power terminal VDDP.

In some embodiments of the present disclosure, the display panel 100 further includes: a source driving circuit 140. The source driving circuit 140 is coupled to the plurality of data lines DL, respectively. Exemplarily, one source driving circuit 140 may be included. Alternatively, two source driving circuits may be included, wherein one source driving circuit is connected to half of the plurality of data lines DL, and the other source driving circuit is connected to the other half of the plurality of data lines DL. Alternatively, the number of the source driving circuits may be set to be 3, 4, or more, which may be determined by design according to the requirements of the practical application, and is not limited in the present disclosure.

In some embodiments of the present disclosure, each pixel circuit includes the first initialization signal terminal VINIT1, as shown in FIG. 26, the display panel 100 further includes: a plurality of first initialization signal lines VL1. The plurality of first initialization signal lines VL1 extend along the column direction of the sub-pixels. Optionally, each of the plurality of first initialization signal lines VL1 is coupled to the first initialization signal terminals VINIT1 of the pixel circuits in one column of sub-pixels.

Illustratively, as shown in FIG. 26, the display panel 100 further includes: a first initialization signal terminal VP1. The plurality of first initialization signal lines VL1 are connected to a first initialization signal bus coupled to the first initialization signal terminal VP1.

In some embodiments of the present disclosure, each pixel circuit includes the third initialization signal terminal VINIT3, and the display panel further includes: a plurality of third initialization signal lines. The plurality of third initialization signal lines extend along the column direction of the sub-pixels. Optionally, each of the plurality of third initialization signal lines is coupled to the third initialization signal terminals VINIT3 of the pixel circuits in a corresponding column of sub-pixels.

In some embodiments of the present disclosure, the display panel further includes: a gate driving circuit 110, a light-emitting control circuit 120, and a compensation control circuit 130. The gate driving circuit 110 is coupled to the plurality of scan signal lines GAL, the light-emitting control circuit 120 is coupled to the plurality of light-emitting control signal lines EML, and the compensation control circuit 130 is coupled to the plurality of compensation control signal lines CSL. The gate driving circuit 110 is configured to input scan signals to the plurality of scan signal lines GAL, the light-emitting control circuit 120 is configured to input light-emitting control signals to the plurality of light-emitting control signal lines EML, and the compensation control circuit 130 is configured to input compensation control signals to the plurality of compensation control signal lines CSL.

In the embodiment of the present disclosure, thin film transistors (TFT) may be formed on the array substrate of the display panel by using a gate driver on array (GOA) technology, so as to form the gate driving circuit 110, the light-emitting control circuit 120, and the compensation control circuit 130. In this way, the gate driving circuit 110, the light-emitting control circuit 120, and the compensation control circuit 130 may be equivalent to GOA circuits. In addition, according to the embodiment of the present disclosure, by sharing the signal terminals of the pixel circuits, only three groups of GOA circuits are needed to control the pixel circuits to operate. Therefore, the number of GOA circuits can be reduced, and a narrow border can be realized.

An embodiment of the present disclosure further provides a display apparatus, as shown in FIG. 26, the display apparatus may include: a display panel 100 and a timing controller 200. Illustratively, in each display frame, the timing controller 200 may receive display data of an image to be displayed and input corresponding control signals to the gate driving circuit 110, the light-emitting control circuit 120, and the compensation control circuit 130, respectively, so that the gate driving circuit 110 outputs corresponding scan signals to the scan signal lines GAL, the light-emitting control circuit 120 outputs corresponding light-emitting control signals to the light-emitting control signal lines EML, and the compensation control circuit 130 outputs corresponding compensation control signals to the compensation control signal lines CSL. The timing controller 200 may further correspondingly process the received display data and transmit the processed display data to the source driving circuit 140. The source driving circuit 140 may input corresponding data voltages to the data lines DL according to the received display data, so that the corresponding data voltages are input to the pixel circuits, thereby implementing the image display function of the display frame.

In specific implementation, in the embodiment of the present disclosure, the display apparatus may be: any product or component with a display function, such as a mobile phone, a tablet computer, a television, a display, a notebook computer, a digital photo frame, a navigator or the like. Other essential components of the display apparatus are understood by a person skilled in the art, and are not described herein and should not be construed as limiting the present disclosure.

While preferred embodiments of the present disclosure have been described, additional variations and modifications in these embodiments may occur to one of ordinary skill in the art once they learn of the basic inventive concepts. Therefore, it is intended that the appended claims are interpreted as including the preferred embodiments and all variations and modifications that fall within the scope of the present disclosure.

It will be apparent to one of ordinary skill in the art that various changes and modifications may be made in the embodiments of the present disclosure without departing from the spirit and scope of the present disclosure. Thus, if these modifications and variations of the embodiments of the present disclosure fall within the scope of the claims of the present disclosure and their equivalents, the present disclosure is also intended to include such modifications and variations.

1. A pixel circuit, comprising:
a light-emitting device;
a driving transistor configured to generate a driving current for driving the light-emitting device to emit light according to a data voltage;
a coupling control circuit coupled to a first node, and a gate electrode and a second electrode of the driving transistor and configured to stabilize voltages at the first node, and the gate electrode and the second electrode of the driving transistor;
a signal writing circuit coupled to the first node and a first electrode of the driving transistor and configured to provide a signal from a data signal terminal to the first node in response to a signal from a scan signal terminal, and to provide a signal from a first power terminal to the first electrode of the driving transistor in response to a signal from a light-emitting control signal terminal; and
a threshold compensation circuit coupled to the driving transistor and configured to write a threshold voltage of the driving transistor to the gate electrode of the driving transistor.

2. The pixel circuit of claim 1, wherein the coupling control circuit comprises: a first coupling control sub-circuit and a second coupling control sub-circuit;
the first coupling control sub-circuit is configured to stabilize the voltage at the gate electrode of the driving transistor and the voltage at the first node; and
the second coupling control sub-circuit is configured to stabilize the voltage at the second electrode of the driving transistor and stabilize the voltage at the gate electrode of the driving transistor or the first node.

3. The pixel circuit of claim 2, wherein the first coupling control sub-circuit comprises: a first capacitor; and
a first plate of the first capacitor is coupled to the gate electrode of the driving transistor, and a second plate of the first capacitor is coupled to the first node; and
the second coupling control sub-circuit comprises: a second capacitor; and a first plate of the second capacitor is coupled to the second electrode of the driving transistor, and a second plate of the first capacitor is coupled to the gate electrode of the driving transistor or the first node.

4. (canceled)

5. The pixel circuit of claim 1, wherein the threshold compensation circuit is further configured to initialize the first node and the gate electrode, the first electrode, and the second electrode of the driving transistor; and
wherein the threshold compensation circuit comprises, a first threshold compensation sub-circuit, a second threshold compensation sub-circuit, and a third threshold compensation sub-circuit;
the first threshold compensation sub-circuit is configured to electrically connect the first node to the second electrode of the driving transistor or provide a signal from a first initialization signal terminal to the first node in response to a signal from a first compensation control signal terminal;
the second threshold compensation sub-circuit is configured to electrically connect the electrode of the driving transistor to the first electrode of the driving transistor in response to a signal from a second compensation control signal terminal; and
the third threshold compensation sub-circuit is configured to provide the signal from the second initialization signal terminal to the second electrode of the driving transistor in response to a signal from a third compensation control signal terminal.

6. (canceled)

7. The pixel circuit of claim 5, wherein in a display frame, an active level of the signal from at least one of the first compensation control signal terminal, the second compensation control signal terminal, and the third compensation control signal terminal appears before an active level of the signal from the scan signal terminal.

8. The pixel circuit of claim 5, wherein in a display frame, a sustain duration of the active level of the signal from at least one of the first compensation control signal terminal, the second compensation control signal terminal, and the third compensation control signal terminal is greater than a sustain duration of the active level of the signal from the scan signal terminal.

9. The pixel circuit of claim 5, wherein at least two of the first compensation control signal terminal, the second compensation control signal terminal, and the third compensation control signal terminal are a same signal terminal.

10. The pixel circuit of claim 5, wherein the first threshold compensation sub-circuit comprises: a first transistor; and
a gate electrode of the first transistor is coupled to the first compensation control signal terminal, a first electrode of the first transistor is coupled to the first node, and a second electrode of the first transistor is coupled to the second electrode of the driving transistor or the first initialization signal terminal;
the second threshold compensation sub-circuit comprises: a second transistor, and a gate electrode of the second transistor is coupled to the second compensation control signal terminal, a first electrode of the second transistor is coupled to the gate electrode of the driving transistor, and a second electrode of the second transistor is coupled to the first electrode of the driving transistor; and
the third threshold compensation sub-circuit comprises: a third transistor; and a gate electrode of the third transistor is coupled to the third compensation control signal terminal, a first electrode of the third transistor is coupled to the second initialization signal terminal, and a second electrode of the third transistor is coupled to the second electrode of the driving transistor.

11-12. (canceled)

13. The pixel circuit of claim 1, wherein the signal writing circuit comprises: a fourth transistor and a fifth transistor;
a gate electrode of the fourth transistor is coupled to the scan signal terminal, a first electrode of the fourth transistor is coupled to the data signal terminal, and a second electrode of the fourth transistor is coupled to the first node; and
a gate electrode of the fifth transistor is coupled to the light-emitting control signal terminal, a first electrode of the fifth transistor is coupled to the first power terminal, and a second electrode of the fifth transistor is coupled to the first electrode of the driving transistor.

14. The pixel circuit of claim 1, wherein the pixel circuit further comprises: a reset circuit; and
the reset circuit is configured to provide a signal from a third initialization signal terminal to the second electrode of the driving transistor in response to a signal from a reset signal terminal.

15. The pixel circuit of claim 14, wherein the reset signal terminal and the scan signal terminal are a same signal terminal; and
wherein the reset circuit comprises: a sixth transistor; and
a gate electrode of the sixth transistor is coupled to the reset signal terminal, a first electrode of the sixth transistor is coupled to the third initialization signal terminal, and a second electrode of the sixth transistor is coupled to the second electrode of the driving transistor.

16. (canceled)

17. The pixel circuit of claim 5, wherein at least two of the first initialization signal terminal, the second initialization signal terminal, and the third initialization signal terminal are a same signal terminal.

18. The pixel circuit of claim 1, wherein an anode of the light-emitting device is coupled to the second electrode of the driving transistor, and a cathode of the light-emitting device is coupled to a second power terminal; and
at least one of the first initialization signal terminal, the second initialization signal terminal and the third initialization signal terminal is a same signal terminal as the second power terminal.

19. The pixel circuit of claim 1, wherein the pixel circuit further comprises: an initialization circuit; and
the initialization circuit is configured to provide a signal from a fourth initialization signal terminal to the gate electrode of the driving transistor in response to a signal from a fourth compensation control signal terminal.

20. The pixel circuit of claim 19, wherein the initialization circuit comprises: a seventh transistor; and
a gate electrode of the seventh transistor is coupled to the fourth compensation control signal terminal, a first electrode of the seventh transistor is coupled to the fourth initialization signal terminal, and a second electrode of the seventh transistor is coupled to the gate electrode of the driving transistor; and
wherein the fourth initialization signal terminal is a same signal terminal as the first power terminal.

21. (canceled)

22. A display panel, comprising:
a plurality of sub-pixels; wherein each of the plurality of sub-pixels comprises the pixel circuit of claim 1.

23. The display panel of claim 22, wherein the display panel further comprises:
a plurality of scan signal lines; wherein each of the plurality of scan signal lines is coupled to the scan signal terminals of the pixel circuits in a corresponding row of sub-pixels;
a gate driving circuit coupled to the plurality of scan signal lines; wherein the gate driving circuit is configured to input scan signals to the plurality of scan signal lines, respectively;
a plurality of light-emitting control signal lines; wherein each of the plurality of light-emitting control signal lines is coupled to the light-emitting control signal terminals of the pixel circuits in a corresponding row of sub-pixels;
a light-emitting control circuit coupled to the plurality of light-emitting control signal lines; wherein the light-emitting control circuit is configured to input light-emitting control signals to the plurality of light-emitting control signal lines, respectively;
a plurality of compensation control signal lines; wherein each of the plurality of compensation control signal lines is coupled to the first compensation control signal terminals of the pixel circuits in a corresponding row of sub-pixels; and
a compensation control circuit coupled to the plurality of compensation control signal lines; wherein the compensation control circuit is configured to input compensation control signals to the plurality of compensation control signal lines, respectively; and
each of the plurality of scan signal lines is coupled to reset signal terminals of the pixel circuits in a corresponding row of sub-pixels; and/or
each of the plurality of compensation control signal lines is coupled to second compensation control signal terminals of the pixel circuits in a corresponding row of sub-pixels; and/or
each of the plurality of compensation control signal lines is coupled to third compensation control signal terminals of the pixel circuits in a corresponding row of sub-pixels.

24. (canceled)

25. A display apparatus, comprising the display panel of claim 22.

26. A method for driving the pixel circuit of claim 1, wherein each of a plurality of consecutive display frames comprises an initialization stage, a threshold compensation stage, a data writing stage and a luminescent stage, and the method comprises:
in the initialization stage, providing, by the signal writing circuit, a signal from the first power terminal to the first electrode of the driving transistor in response to a signal from the light-emitting control signal terminal, and stabilizing, by the coupling control circuit, the voltages at the first node, the gate electrode and the second electrode of the driving transistor;
in the threshold compensation stage, writing, by the threshold compensation circuit, the threshold voltage of the driving transistor to the gate electrode of the driving transistor, and stabilizing, by the coupling control circuit, the voltages at the first node, the gate electrode and the second electrode of the driving transistor;
in the data writing stage, providing, by the signal writing circuit, a signal from the data signal terminal to the first node in response to a signal from the scan signal terminal, and stabilizing, by the coupling control circuit, the voltages at the first node, the gate electrode and the second electrode of the driving transistor; and
in the luminescent stage, providing, by the signal writing circuit, a signal from the first power terminal to the first electrode of the driving transistor in response to a signal from the light-emitting control signal terminal, stabilizing, by the coupling control circuit, the voltages at the first node, the gate electrode and the second electrode of the driving transistor, and generating, by the driving transistor, a driving current for driving the light-emitting device to emit light according to the data voltage, to drive the light-emitting device to emit light;
wherein in each display frame, the voltage from the first power terminal is at a high level.

27. The driving method of claim 26, wherein in the initialization stage, the driving method further comprises:
initializing, by the threshold compensation circuit, the first node and the gate electrode, the first electrode, and the second electrode of the driving transistor; and
there is a black frame insertion between any two adjacent ones of at least some of the plurality of display frames, and the method further comprises:
in the black frame insertion, providing, by the signal writing circuit, a signal from the first power terminal to the first electrode of the driving transistor in response to a signal from the light-emitting control signal terminal; initializing, by the threshold compensation circuit, the first mode and the gate electrode, the first electrode, and the second electrode of the transistor; and stabilizing, by the coupling control circuit, the voltages at the first node, the gate electrode and the second electrode of the driving transistor, wherein the voltage from the first power terminal is at a low level.

28. (canceled)
